(19) United States
(12) Patent Application Publication
(10) Pub. No.: US 2010/0088338 A1
(43) Pub. Date: Apr. 8, 2010

(54) RED FLAG IDENTIFICATION VERIFICATION SYSTEM AND METHOD

(76) Inventors: DONALD GORDON PAVONI, JR., Orland Park, IL (US); KEVIN THOMAS HURST, Tinley Park, IL (US); LANGCHI ZHU, Chicago, IL (US)

Correspondence Address: CARDINAL LAW GROUP, 1603 Orrington Avenue, Suite 2000, Evanston, IL, 60201, US

(21) Appl. No.: 12/573,673

(22) Filed: Oct. 5, 2009

Related U.S. Application Data
(60) Provisional application No. 61/102,765, filed on Oct. 3, 2008.

(51) Int. Cl. G06F 17/30

(52) U.S. Cl. 707/770; 709/206; 707/E17.014; 707/E17.032

(57) ABSTRACT

Embodiments relate to systems and methods for verifying an individual's identify and preventing identify theft. The system comprises at least one input device, third party databases, network and processing unit. The input device is used to enter an individual's consumer identity information, while the third party databases stores identity data. The network communicates with the third party databases and the at least one input device, while the processing unit communicates with at least one of the input devices, third-party databases and the network. The processing unit contains instructions for receiving the individual's consumer identify information from the at least one input device; searching the third party databases using the received identify information to identify at least one pattern of interest in at least one alert category; scoring at least the one pattern of interest as a function of at least one Red Flag Rule; and communicating the score.

### RELATE APPLICATION INFORMATION

The application claims priority to, and benefit from, U.S. Provisional Application No. 61/102,765 filed Oct. 3, 2009, the contents of which are incorporated herein by reference.

### FIELD OF THE INVENTION

The invention relates to identification systems and methods. More particularly, embodiments relate to identification systems and methods that prevent identity theft.

### BACKGROUND OF THE INVENTION

Financial institutions and creditors are now required to develop and implement written identity theft prevention programs under the new “Red Flags Rule.” The Red Flags Rule is part of the Fair and Accurate Credit Transactions (FACT) Act of 2003. Under these Rules, financial institutions and creditors with covered accounts must have identity theft prevention programs in place by Nov. 1, 2009 to identify, detect, and respond to patterns, practices, or specific activities that could indicate identity theft.

For the foregoing reasons, it would be desirable to have an identification system and method that prevents identity theft in compliance with applicable laws.

### SUMMARY OF THE INVENTION

One embodiment relates to systems and methods for verifying an individual's identify and preventing identify theft. The system comprises at least one input device, third party databases, a network and a processing unit. The at least one input device is used to enter an individual's consumer identity information, while the third party databases stores identity data. The network communicates with the third party databases and the at least one input device, while the processing unit communicates with at least one of input devices, the third party databases and the network. The processing unit contains instructions operating thereon for receiving the individual's consumer identify information from the at least one input device; searching the third party databases using the received individual's consumer identify information to identify at least one pattern of interest in at least one alert category; scoring at least the one pattern of interest as a function of at least one Red Flag Rule; and communicating the score to a user.

Another embodiment relates to a system for verifying an individual's identity and preventing identify theft, the system comprising at least one input device, third party databases; a network, and a processing unit. The at least one input device is used for entering an individual's consumer identity information and the third party databases store identity data. The network communicates with the third party databases and the at least one input device, while the processing unit communicate with the at least one input device, the third party databases and the network. The processing unit contains instructions operating thereon for verifying the individual's identity; identifying a theft prevention plan; providing user training; providing reports; providing red flag notification; enabling user administration; and enabling partnering with other users and administering such partnering.

Still another embodiment relates to a method for verifying an individual's identify and preventing identify theft, the method comprising entering an individual's consumer identity information using at least one input device; and communicating with third party databases storing identity data using a network communicating with at least the one input device. The method also comprises processing the entered individual's consumer identity information using a processing unit communicating with at least one of the input devices, third party databases and the network. The processing unit contains instructions operating thereon for receiving the individual's consumer identify information from the input device; searching the third part databases using the received individual's consumer identify information to identify at least one pattern of interest in at least one alert category; scoring at least the one pattern of interest as a function of at least one Red Flag Rule; and communicating the score to a user.

The foregoing and other features and advantages of the invention will become further apparent from the following detailed description of the presently preferred embodiment, read in conjunction with the accompanying drawings. The drawings are not to scale. The detailed description and drawings are merely illustrative of the invention rather than limiting, the scope of the invention being defined by the appended claims and equivalents thereof.

### BRIEF DESCRIPTION OF THE DRAWINGS

FIG. 1 depicts a system in accordance with one embodiment of the present invention;

FIG. 2 depicts a block diagram illustrating the instructions operating on the system of FIG. 1 in accordance with one embodiment;

FIG. 3 depicts a screenshot illustrating the Login Screen in accordance with one embodiment;

FIG. 4 depicts a screenshot illustrating the Red Flag Resolution Tool Main Menu Screen in accordance with one embodiment;

FIG. 5 depicts a screenshot illustrating an Search Customer screen in accordance with one embodiment;

FIG. 6 depicts a screenshot illustrating another Search Customer Screen in accordance with one embodiment;

FIG. 7 depicts a screenshot illustrating the Customer Search Result screen in accordance with one embodiment;

FIG. 8 depicts a screenshot illustrating still another Search Customer Screen in accordance with one embodiment;

FIG. 9 depicts a screenshot illustrating another Customer Search Result screen in accordance with one embodiment;

FIG. 10 depicts a screenshot illustrating the View All Customers Screen in accordance with one embodiment;

FIG. 11 depicts the scanner of FIG. 1 in accordance with one embodiment;

FIG. 12 depicts a screenshot illustrating the Scan License Face Up Screen in accordance with one embodiment;

FIG. 13 depicts a screenshot illustrating the Scan License Face Down Screen in accordance with one embodiment;

FIG. 14 depicts another view of the scanner of FIG. 1 in accordance with one embodiment;

FIG. 15 depicts a screenshot illustrating the Preliminary Results Screen in accordance with one embodiment;

FIG. 16 depicts a screenshot illustrating the Final Results of all Information Successfully Obtained Screen in accordance with one embodiment;

FIG. 17 depicts a screenshot illustrating the Adding Customers Screen in accordance with one embodiment;

FIG. 18 depicts a screenshot illustrating the Compliance Status Screen in accordance with one embodiment;

FIG. 19 depicts a screenshot illustrating the optional Identity Discrepancy Issues Screen in accordance with one embodiment;

FIG. 20 depicts a screenshot illustrating the Red Flag Scoreboard Screen in accordance with one embodiment;

FIG. 21 depicts a screenshot illustrating the Red Flag Resolution Status Screen in accordance with one embodiment;

FIG. 22 depicts a screenshot illustrating the Incomplete Information Screen in accordance with one embodiment;

FIG. 23 depicts a screenshot illustrating the Overridden Screen in accordance with one embodiment;

FIG. 24 depicts a screenshot illustrating the Address Check Screen in accordance with one embodiment;

FIG. 25 depicts a screenshot illustrating the Identity Resolution Screen in accordance with one embodiment;

FIG. 26 depicts a screenshot illustrating the Identity Check Results Screen in accordance with one embodiment;

FIG. 27 depicts a screenshot illustrating another Identity Check Results Screen in accordance with one embodiment;

FIG. 28 depicts a screenshot illustrating the Terror Watch List Screen in accordance with one embodiment;

FIG. 29 depicts a screenshot illustrating the Terrorist Watch List Search Results Screen in accordance with one embodiment;

FIG. 30 depicts a screenshot illustrating the Terror Watch List Match Screen in accordance with one embodiment;

FIG. 31 depicts a screenshot illustrating another Terrorist Watch List Screen in accordance with one embodiment;

FIG. 32 depicts a screenshot illustrating the Notes Screen in accordance with one embodiment;

FIG. 33 depicts a screenshot illustrating the Status Review Screen in accordance with one embodiment;

FIG. 34 depicts a screenshot illustrating the Red Flag Compliance Status Report Screen in accordance with one embodiment;

FIG. 35 depicts a screenshot illustrating the Help Screen in accordance with one embodiment;

FIG. 36 depicts a screenshot illustrating another Help Screen in accordance with one embodiment;

FIG. 37 depicts a screenshot illustrating the Show Help Screen in accordance with one embodiment;

FIG. 38 depicts a screenshot illustrating the ITPP Process Screen in accordance with one embodiment;

FIG. 39 depicts a screenshot illustrating the Identity Theft Prevention Program Screen in accordance with one embodiment;

FIG. 40 depicts a screenshot illustrating the Identity Theft Prevention Program Creation and Maintenance Screen in accordance with one embodiment;

FIG. 41 depicts a screenshot illustrating the Risk Assessment and Covered Account Identification Screen in accordance with one embodiment;

FIG. 42 depicts a screenshot illustrating the Risk Assessment and Covered Account Identification Screen in accordance with one embodiment;

FIG. 43 depicts a screenshot illustrating the Overseeing of Service Providers Screen in accordance with one embodiment;

FIG. 44 depicts a screenshot illustrating the Overseeing of Service Providers Screen in accordance with one embodiment;

FIG. 45 depicts a screenshot illustrating the Identity Theft Incident Report Screen in accordance with one embodiment;

FIG. 46 depicts a screenshot illustrating the Transaction History Screen in accordance with one embodiment;

FIG. 47 depicts a screenshot illustrating the Detailed Information Screen in accordance with one embodiment;

FIG. 48 depicts a screenshot illustrating the Previous ITPP Reviews Screen in accordance with one embodiment;

FIG. 49 depicts a screenshot illustrating the Main Training Screen in accordance with one embodiment;

FIG. 50 depicts a screenshot illustrating the Beginning the Compliance Training Process Screen in accordance with one embodiment;

FIG. 51 depicts a screenshot illustrating the Red Flag Rules Training Screen in accordance with one embodiment;

FIG. 52 depicts a screenshot illustrating the Red Flag Compliance Examination Screen in accordance with one embodiment;

FIG. 53 depicts a screenshot illustrating the Test Results Screen in accordance with one embodiment;

FIG. 54 depicts a screenshot illustrating the Report Selection Screen in accordance with one embodiment;

FIG. 55 depicts a screenshot illustrating the Create Search Criteria Screen in accordance with one embodiment;

FIG. 56 depicts a screenshot illustrating the Report Display Screen in accordance with one embodiment;

FIG. 57 depicts a screenshot illustrating the Report Display Screen in accordance with one embodiment;

FIG. 58 depicts a screenshot illustrating the Red Flag Violation Email Screen in accordance with one embodiment;

FIG. 59 depicts a screenshot illustrating the Administration Tools Screen in accordance with one embodiment;

FIG. 60 depicts a screenshot illustrating the My Account and Document Download Screen in accordance with one embodiment;

FIG. 61 depicts a screenshot illustrating the Print Document Screen in accordance with one embodiment;

FIG. 62 depicts a screenshot illustrating the Partner Administration Screen in accordance with one embodiment;

FIG. 63 depicts a screenshot illustrating the Customer Maintenance Screen in accordance with one embodiment;

FIG. 64 depicts a screenshot illustrating the Partner Reporting Screen in accordance with one embodiment;

FIG. 65 depicts a screenshot illustrating the Create Search Criteria Screen in accordance with one embodiment;

FIG. 66 depicts a screenshot illustrating the Customer Specific Reporting Screen in accordance with one embodiment;

FIG. 67 depicts a screenshot illustrating the Red Flag Violation Email Screen in accordance with one embodiment; and

FIG. 68 depicts a high level flow diagram illustrating a method in accordance with one embodiment.

Throughout the various figures, like reference numbers refer to like elements.

### DETAILED DESCRIPTION OF PRESENTLY PREFERRED EMBODIMENTS

Financial institutions and creditors are now required to develop and implement written identity theft prevention programs under the new “Red Flags Rule.” Embodiment relate to a Red Flag Rule system and method that comprises, for example, a web-based computer application that assists business, automobile dealers for example, with resolving issues under the Red Flag Rules. Further embodiments ensure that all transactions processed across the Web or network are secure.

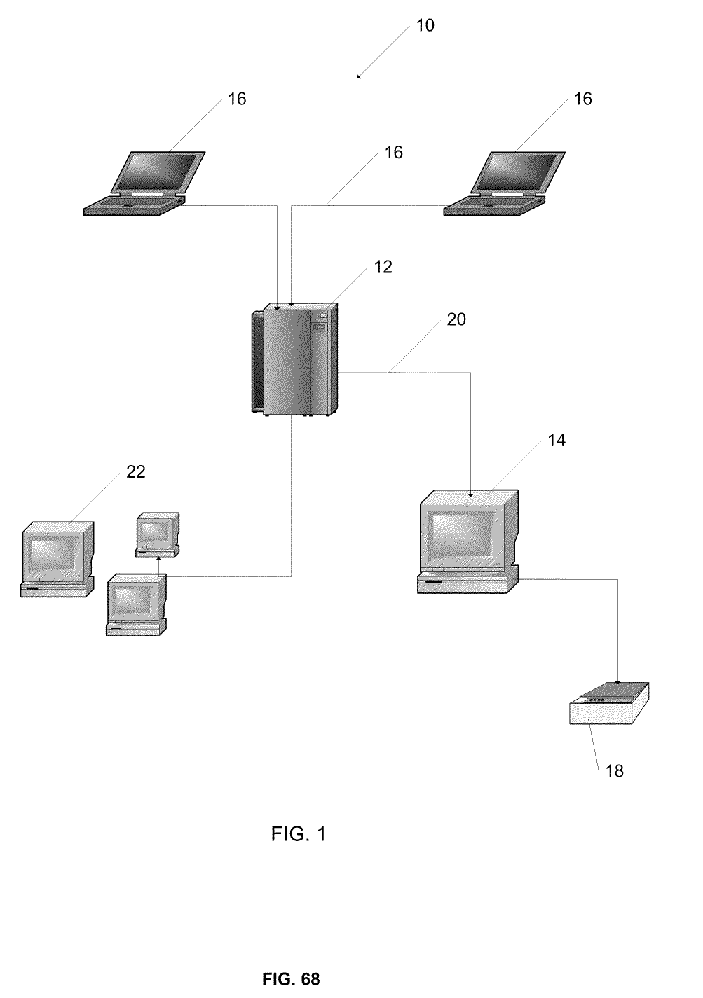

FIG. 1 illustrates a system 10 for verifying an individual's identity and preventing identify theft, in accordance with one embodiment. The system 10 includes a processing unit, host computer or server 12; one or more input devices 14, 16, 18; a network 20 and one or more third party databases 22. In at least one embodiment, the input devices comprise one or more desktops 14 and/or laptops 16 communicating with network 20; and one or more scanners 18 communicating with one or more desktops 14, laptops 16 and/or the processing unit 12 directly via the network 20.

The network 16 comprises any cable, wired, wireless networks or combinations thereof as are known in the art and communicates with one or more desktops/laptops 14 and third party databases 20 storing identity data, banking records, marriage information, driver license information and the like. While desktops and laptops are illustrated, other devices, including netbooks, Personal Digital Assistants (PDAs), cell phones and the like are contemplated.

The processing unit 12 contains instructions operating thereon. In at least one embodiment, such instructions enable the processing unit to receive individual's consumer identify information from the input device and modifying the consumer identify information using wild card characters. Additionally, the instructions enable searching third party databases for identifying at least one pattern of interest in at least one alert category; scoring the at least one pattern of interest as a function of at least one Red Flag Rule; and communicating the score to a user via an email, text, or other communication means or methods.

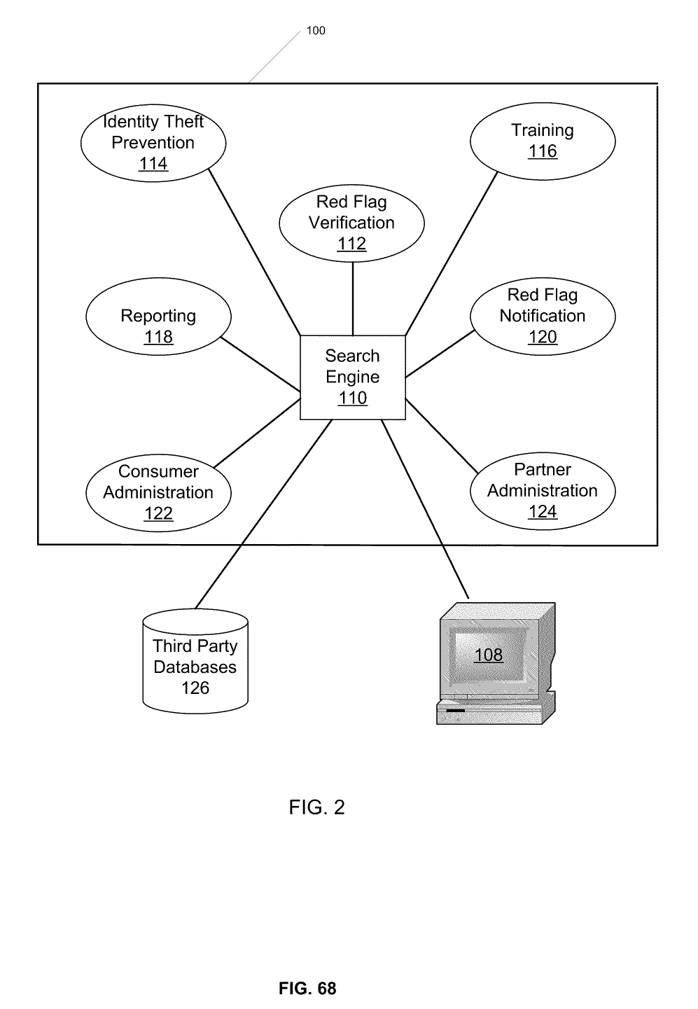

FIG. 2 depicts a block diagram of the system 100 illustrating the instructions operating on the system similar to that of system 10 in accordance with one embodiment. The system 100 includes one or more input devices 108 for entering an individual's consumer identity information into processing unit 110 through the network similar to that disclosed previously. As illustrated, the system 100 includes instructions enabling a Red Flag Verification Tool or module 112 to verify the individual's (or user's) identity; an Identity Theft Prevention Plan Tool or module 114 to identify a theft prevention plan; a Training Tool or Module 116 to provide user training; a Reporting Tool or module 118 to provide or more reports to the user; a Red Flag Email Notification Process Tool or module 120 to provide red flag notification; a Customer Administration Function Tool or module 122 enabling user administration; and a Partner Administration Function Tool or module 124 enabling partnering with other users and administering such partnering. Additionally, one or more third party databases 126 are shown communicating with the processing unit 100.

Further, as provided previously, the processing unit 110 of the system 100 receives the individual's consumer identify information from the input devices 108 via the network; searches the third part databases 126 using the received consumer identify information to identify at least one pattern of interest in at least one alert category; scores the at least one pattern of interest according to at least one Red Flag Rule; and communicates the score to at least the user.

The present invention comprises two embodiments of the Red Flag Rules Verification Tool, Express and Comprehensive embodiments. Both embodiments feature attempts to resolve specific Red Flag Rules applicable to car dealers and the like. Most of the rules can be resolved with simple questions provided by the system. Information discrepancies can be uncovered by comparing data to third party databases.

One embodiment conducts a traditional OFAC check using a customer or individual's first and last name. Embodiments of the Red Flag Rule Verification system take the OFAC check to another level by allowing the use of wild card characters and the search of aliases to locate someone on the OFAC list.

The Red Flag Scoreboard provides the user with an opportunity to view how many of the Red Flag Rules are in each of the four compliance statuses, Complaint, Not Resolved, Non Complaint and Not Applicable.

The Customer Compliance Summary Report includes a summary of the Compliance process for this individual or customer. This document may be filed in the Customer's deal jacket.

The Comprehensive embodiment obtains additional information about the customer from additional third party databases that specialize in identity information. Some of the features available only with the Comprehensive embodiment include: the ability to ask several ‘out of wallet’ questions to verify the Customer's identity; comparing the Customer's Drivers License Address information with address information maintained by large Credit Agencies; verifying that the Customer's Social Security Number does not appear on the SSN Death Master list; verifying that the Customer's address and/or phone numbers are not associated with high risk activity and the like.

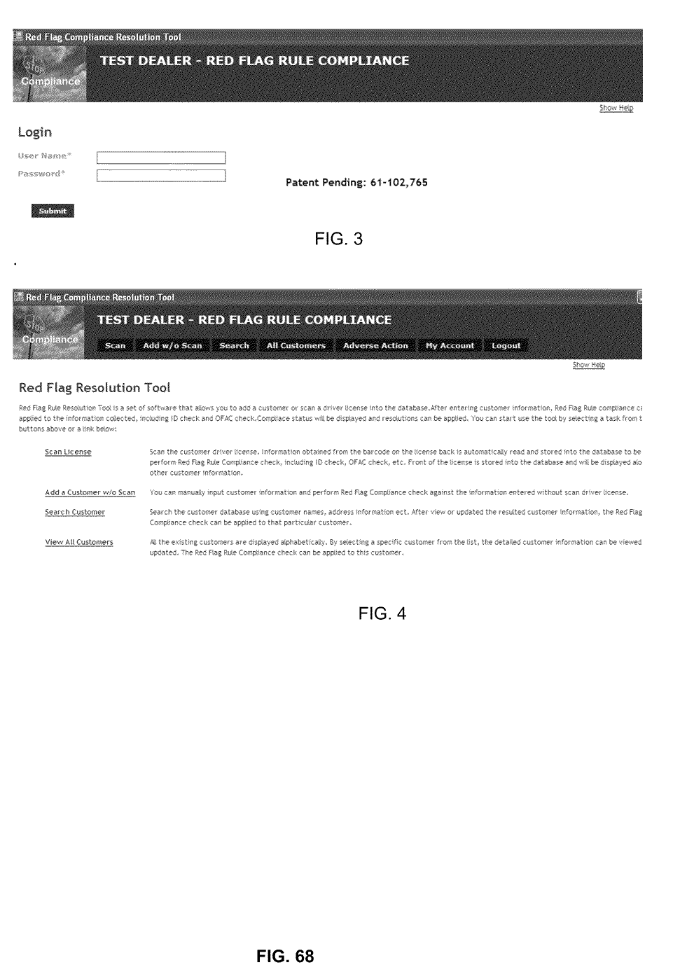

After clicking the Launching Tool button, the system displays the first or Login Screen similar to that illustrated in FIG. 3. The user enters the correct user name and password to reach the Red Flag Resolution Tool screen.

After a successful login, the system displays the Red Flag Resolution Tool Main Menu as illustrated in FIG. 4. From the main menu, all the other features of the Red Flag Resolution Tool may be reached. The four major functions that may be launched from this screen include the Driver's License Scan, Adding a Customer without a Scan, Customer Search and View All Customers.

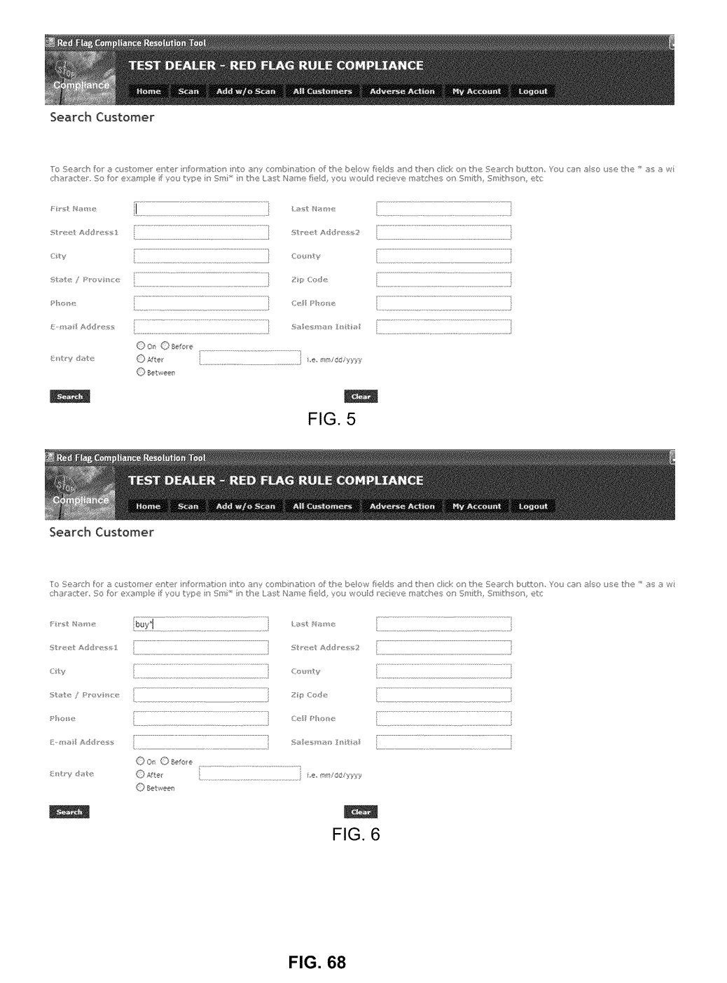

FIG. 5 depicts a screenshot illustrating the Search Customer Screen in accordance with one embodiment. Clicking the Search Customer text or the Search button at the top of the Screen of FIG. 4 brings up the Search Customer screen illustrated in FIG. 5. This function allows users to locate customers already entered into the system for that business.

To locate a customer, the user enters information into the correct field(s), however, not all the fields have to be filled in order to locate a customer. In at least one embodiment, asterisks may be used as wild card characters to simplify the search. For example, if the user is looking for a customer whose first name is “Buyer”, a search can be executed by entering just “Buy” in the first name field with an asterisk (Buy*) and clicking the search button.

FIG. 6 depicts a screenshot illustrating another Search Customer Screen in accordance with one embodiment. If the search is successful, the Customer Search Result screen (FIG. 6) will appear. From this screen, if the customer is correct, clicking on the Select button on the far left side of the screen brings up the Customer Screen.

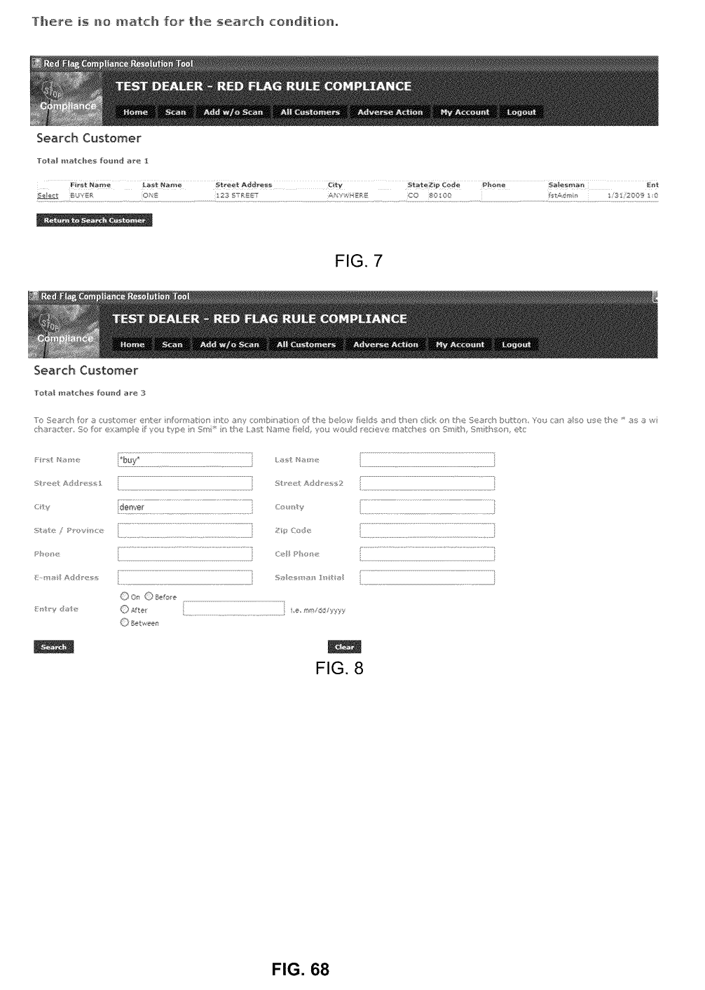

FIG. 7 depicts a screenshot illustrating the Customer Search Result screen. For an unsuccessful search, a message underneath the Search Customer Screen label will appear that saying: “There is no match for the seek condition.”

FIG. 8 depicts a screenshot illustrating still another Search Customer Screen. It is not necessary to use the wildcard character but it can be helpful to limit or restrict a search. Inserting asterisks on both sides of the search term acts as a “contains within”. For example, in FIG. 8, the search is set for first name=*buy* and the city=Denver.

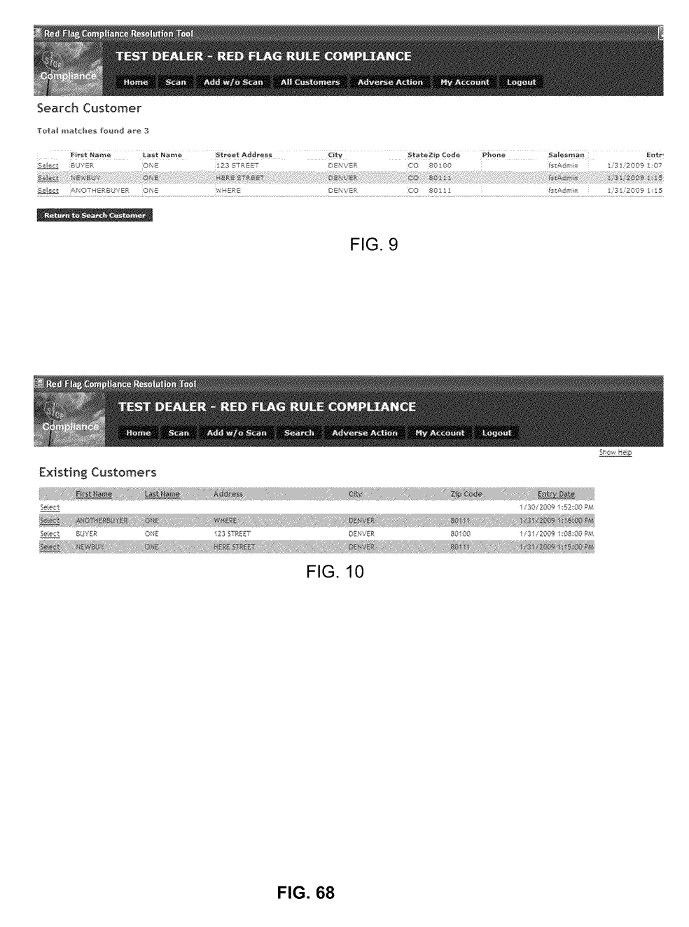

After clicking the search button, the results shown in FIG. 9 will be displayed. In the illustrated example, three customer records are returned. For one record, the first name starts with Buy and the remaining two records include Buy somewhere within the first name. All three records are from Denver. The wildcard feature in more than one field when doing the search. Not using the wild card keep results in a search for an exact match for the data entered.

FIG. 10 depicts a screenshot illustrating the View All Customers Screen. Clicking the View All Customers text or the All Customers button at the top of the screen will bring up the View all Customers. This feature allows a user to view all the customers already entered into the system for that business or dealership.

The underlined columns in FIG. 10, i.e., First Name, Last Name and Entry Date, can be used to sort the data. For example, clicking on the last name field label will sort all of the records in last name order alphabetically from A-Z. Clicking the field label a second time will resort the records alphabetically from Z-A. Only one field can be used as a sort field at any one time.

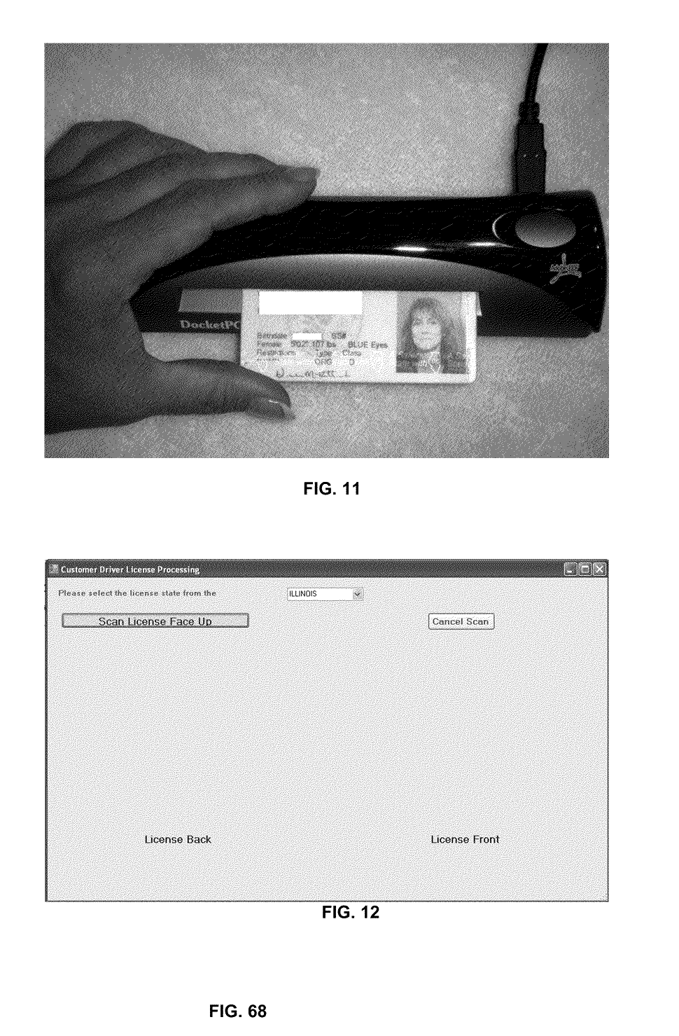

FIG. 11 depicts the scanner of FIG. 1 in accordance with one embodiment. FIG. 12 depicts a screenshot illustrating the Scan License Face Up Screen.

From the main menu screen (See FIG. 3 above) and at the top of almost all of the screens in the application, clicking the “Scan” button at the top of the screen will cause FIG. 12 to appear. The user then follows Steps A through G to complete the process.

A. Insert License into scanner as shown in FIG. 11;

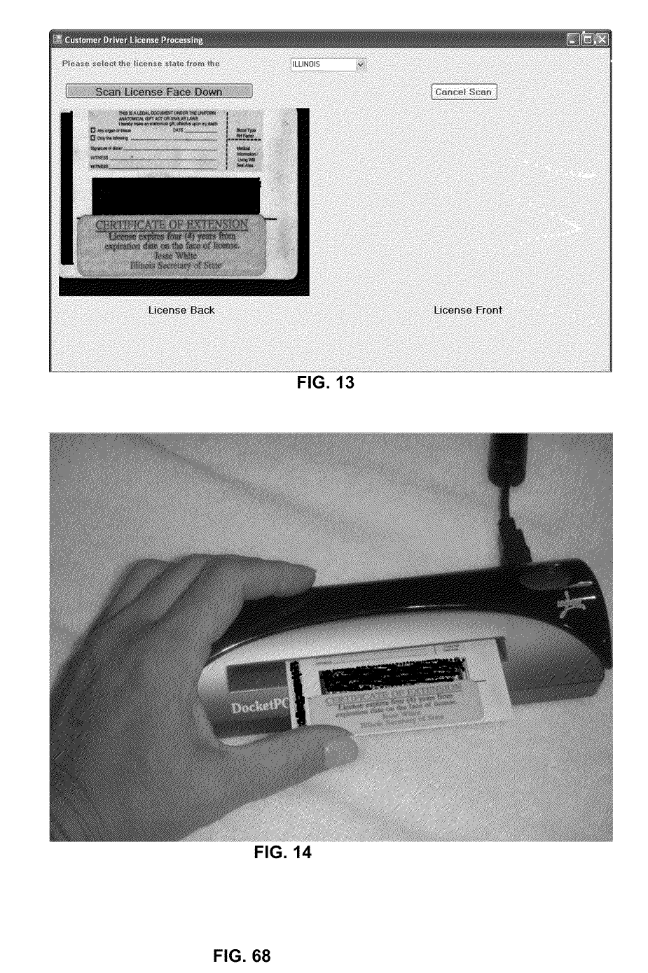

B. Click the button that reads “Scan License Face Up” as illustrated in FIG. 12 resulting in a screen similar to that illustrated in FIG. 13;

C. Verify that the license appears straight and that the bar code is visible and complete (the bar code is blacked out in the illustrated example). If not, the “Cancel Scan” button is clicked and Steps A and B are repeated. If the scan is correct, the user proceeds to Step D.

D. Insert License into scanner as shown in FIG. 14. The License must be face down and on the far right hand side of the scanner.

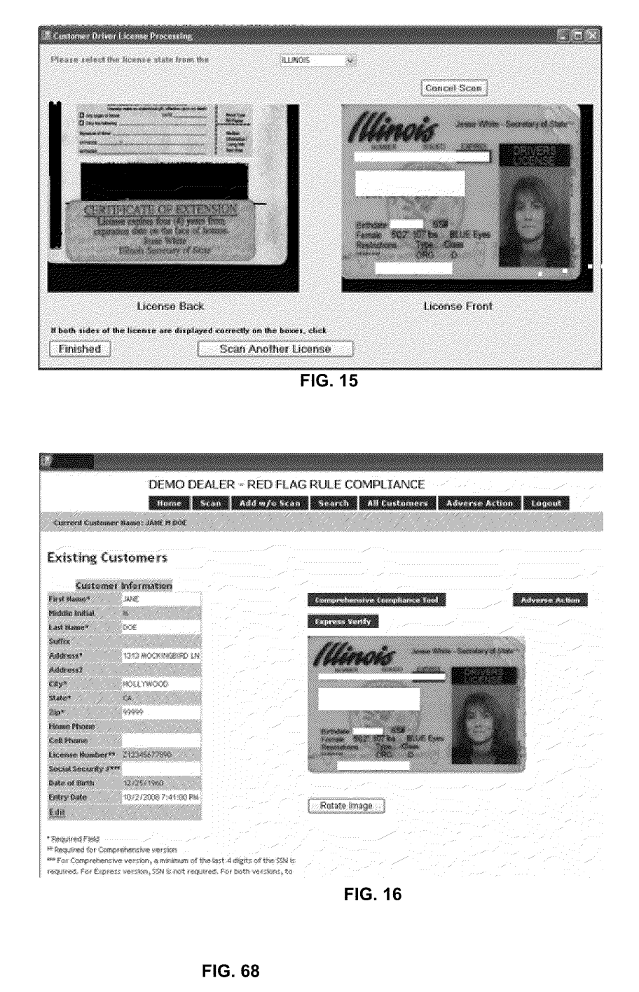

E. Click the button that reads “Scan License Face Down”, the license is pulled through the scanner again. After a short time, a screen similar to FIG. 15 will appear.

F. The screenshot in FIG. 15 illustrates the preliminary results of both scans (front and back). Clicking the “Finished” button at the bottom left hand side of the image below completes the process.

G. FIG. 16 illustrates the screen depicting the final results after the information is successfully obtained from the scanning process. It should be appreciated that Information may be missing for several reasons: the bar code on the license may be scratched or damaged, cause information to be incorrect or missing; the bar code reader itself may be dirty or operating incorrectly; or some states limit the information that can be read from the bar code or don't have a bar code on the Drivers License.

Any information not obtained from the barcode or information that needs to be corrected can be entered by clicking on the edit button in the lower left hand corner of the “Customer Information” section of FIG. 16. Additionally, some states issue driver's licenses for drivers under the age of 21 in portrait instead of the normal landscape. The “Rotate Image” button under the license image itself in FIG. 16 allows users to set the image on the screen correctly.

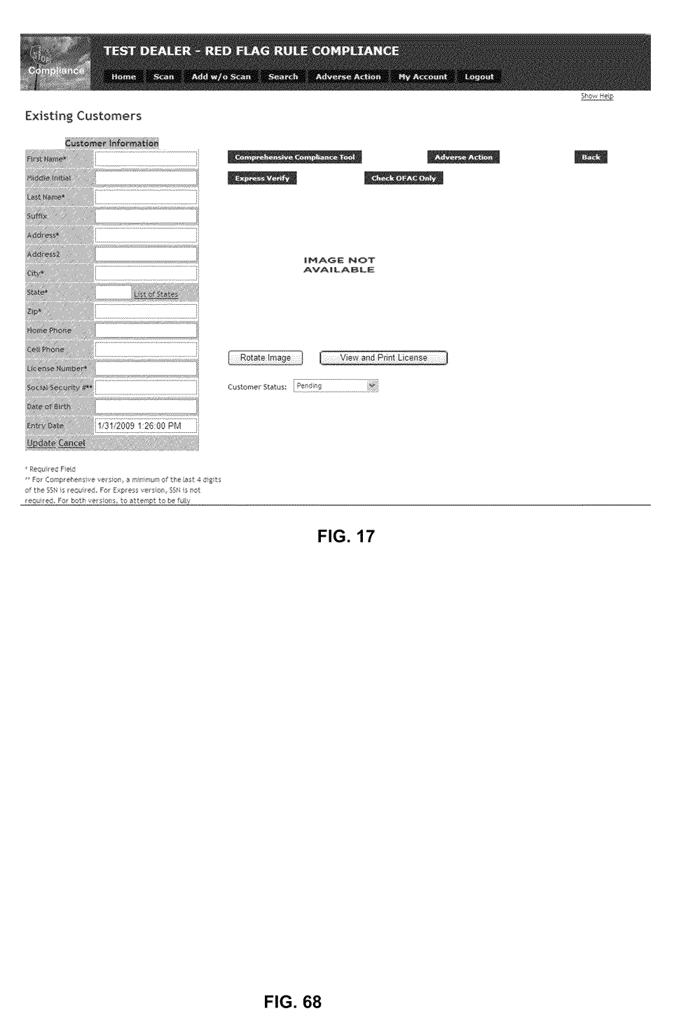

One or more embodiments enable users to add individual or customer information without scanning. From the main menu screen illustrated in FIG. 3, click on the label “Add a Customer w/o scan” or click on the “Add w/o scan button at the top almost all of the screens. A screen similar to that illustrated in FIG. 17 will be displayed.

FIG. 17 depicts 14 possible data fields in the illustrated Customer Screen. Six fields are marked with a single asterisk (First Name, Last Name, Address, City State, Zip Code and the like). These are required fields. The screen also displays two special fields with multiple asterisks, the License Number for example. This means that the Drivers License number is only required for the Comprehensive embodiment but is not required for the Express embodiment. The other special field is the Social Security Number with three asterisks. For the Express embodiment, the SSN is a required field. For the Comprehensive embodiment, only the last four digits of the SSN are required, however, the entire number is needed to conduct a complete Comprehensive check. The other six fields (Middle Initial, Suffix, Address 2, Home Phone, Cell Phone and Date of Birth) are not mandatory.

Upon entering all the data, the Update button should be clicked. Two things can happen. If the update is successful, the Customer Screen will return with the Update button removed and the Edit button in its place. Alternatively, if an error is detected an Error message may be displayed.

The system may display several Error messages during the process. The errors will most likely be due to missing or incomplete information. For example, any field marked with an asterisk is mandatory. Therefore, if the First Name is not entered an error message will appear next to the data field indicating that the First Name field is required. Some fields require a certain minimum number of characters. For example, the Address needs a minimum of 4 characters. If someone entered BOX and hit update, the address field would be flagged with a message indicating that the minimum number was not entered. Other fields that expect a specific format or length may also result in errors.

The process for updating existing Customers is fundamentally the same as the Add process. See FIG. 16 for an example of the Update Customer screen. This screen will appear when the Finish button is clicked from the Scan screen after a successful scan and when the Select button is selected from the Customer Search Result screen for a specific customer. In both instances, information had previously been entered for this Customer.

The Customer Screen illustrated in FIG. 17 includes an Adverse Action button. Clicking this button will provide the Adverse Action processing screen. Information to complete the Adverse Action process as provided below.

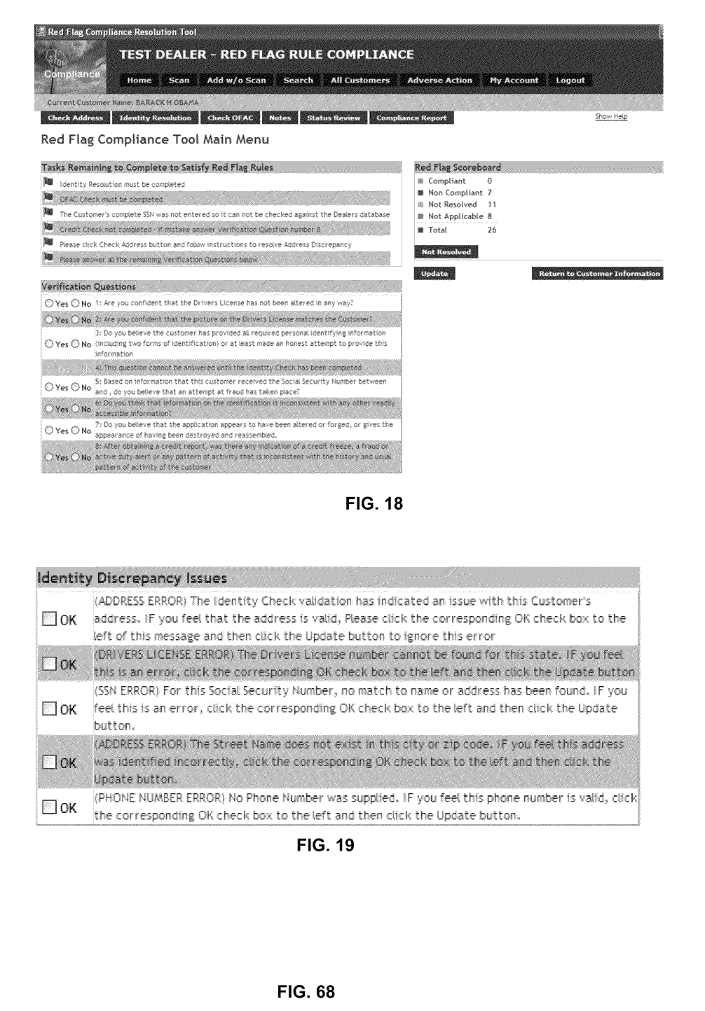

FIG. 18 depicts a screenshot illustrating the Compliance Status Screen in accordance with one embodiment which is displayed when the Comprehensive Compliance Tool or Express Verify button has been clicked. The illustrated screen is divided into a number of Frames including Tasks Remaining to Complete to Satisfy Red Flag Rules, Verification Questions Frame and the Identity Discrepancy Issue Frame.

The Tasks Remaining to Complete to Satisfy Red Flag Rules Frame of FIG. 18, also referred to as the Task Resolution Frame displays several tasks. These tasks must be completed to satisfy the Red Flag Rules. For example, one of the tasks may say “OFAC check must be completed”. This informs the user that they need to click the Check OFAC button at the top of the screen and complete this requirement. Once all tasks in this frame have been completed, the Red Flag Resolution process should be complete.

The most common tasks that will appear on the Compliance Status Screen, and the processes required to resolve them, include Identity Resolution Must Be Completed; Please Answer All The Remaining Verification Questions; OFAC Check Must Be Completed; Please Click Check Address Button and Follow Instructions To Resolve Address; Discrepancy; Credit Check Not Completed; Please Answer All The Remaining Identity Discrepancy Issues Below; The OFAC Check Has Turned Up A Match; and The Customer's Complete SSN Was Not Entered So It Can Not Be Checked Against The Dealers Database. There are other less common tasks that may appear in the Task box. After all tasks have been completed, the message All Tasks have been completed will appear in the task box.

FIG. 19 depicts a screenshot illustrating the Identity Discrepancy Issues Screen in accordance with one embodiment. This is an optional frame that will appear in the Compliance embodiment at the bottom of the screen (See FIG. 18) underneath the Verification questions frame. The Identity Discrepancy Issues frame appears if, during the identity check process, issues have surfaced regarding the customers identity that must be resolved. If there are no such issues, this screen will not appear. Each specific issue will disappear after the corresponding check box on the left has been clicked (checked) and the update button clicked.

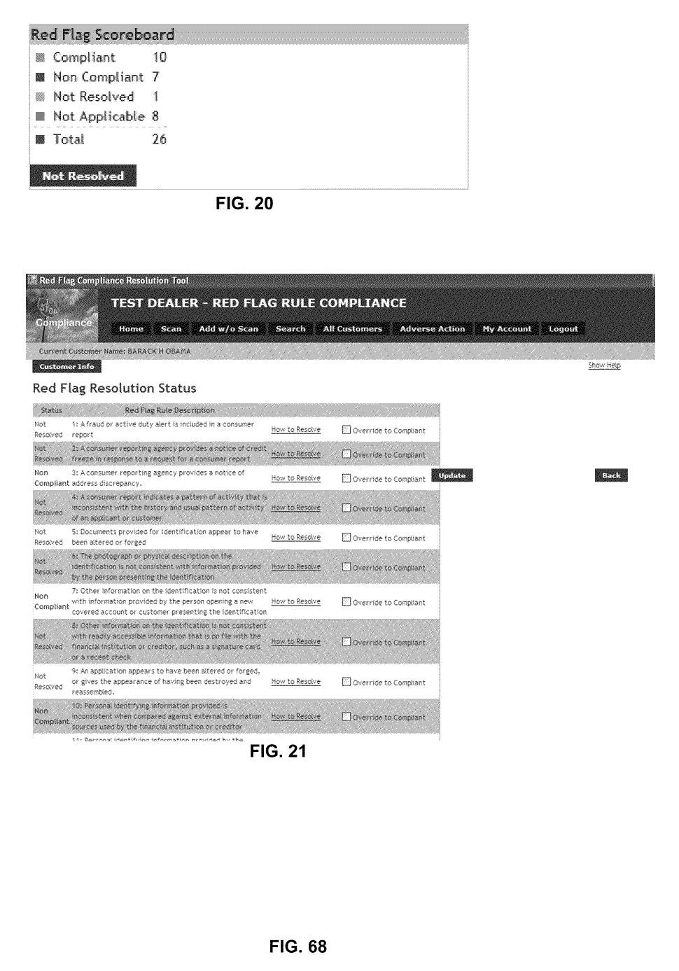

At least one embodiment of the present invention includes a Red Flag Scoreboard that tracks the current status of all the Red Flag Rules (26 rules for example). One goal for using the Compliance Resolution screen is to represent all of the Red Flag rules with a status of Compliant or Not Applicable. For example, as illustrated in FIG. 20, ten of the Red Flag Rules are depicted as Compliant, seven of the Red Flag rules are depicted as Non Compliant and one of the Red Flag Rules is depicted as Not resolved. The seven Non Compliant Rules and one Not Resolved Rule need to be resolved for this customer to be fully compliant.

To help accomplish such fully compliance, click on the Not Resolved button in the lower left hand corner of the Red Flag Scoreboard frame. Clicking this button will bring up the Red Flag Resolution Status screen as illustrated in FIG. 20.

The purpose of the screen depicted in FIG. 21 is to show only those Red Flag Rules with a status of Non Compliant or Not Resolved. Any Red Flag Rule with a Compliant or Not Applicable status will not appear on this screen because it is considered resolved. There is a major difference between Red Flag Rules set to Not Resolved or Non Compliant. A Red Flag Rule with a Not Resolved status has been set that way because not enough information has been processed to satisfy the requirements for that Red Flag rule to be set to Compliant. A status of Non Complaint means that specific information exists that indicates that the compliance requirements for that Red Flag Rule are not being followed.

For each Red Flag rule requiring resolution, the current status of the rule will be followed by a description of the Red Flag Rule. Next to that will be a button titled How to Resolve. Clicking this button will explain what can be done to resolve this rule as illustrated in FIG. 22.

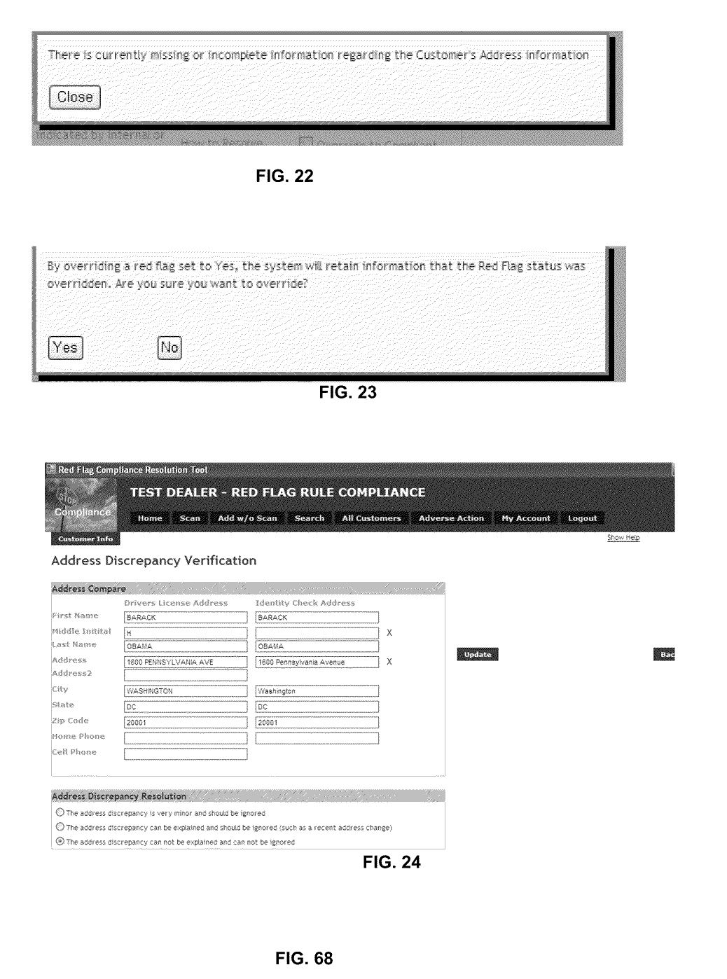

FIG. 21 depicts a screenshot illustrating the Red Flag Resolution Status Screen in accordance with one embodiment. For rules that are Not Complaint, FIG. 21 includes a check box titled Override to Complaint. The purpose of this checkbox is to change the status of a Red Flag Rule from Non Complaint to Complaint when there appears to be evidence to the contrary. In at least one embodiment, the system retains information that the status for this Red Flag Rule was overridden as illustrated by FIG. 23, which depicts a screenshot illustrating the Incomplete Information Screen in accordance with one embodiment.

There are five functions that can be launched from the menu buttons located at the top of the Compliance Status screen (See FIG. 17). Each of these functions will display a new screen. For the Comprehensive embodiments, all five functions can be launched. For the Express embodiment, only the OFAC Check, Notes and Status review functions will appear.

The purpose of this screen illustrated in FIG. 24 is to compare the Customer's Name and Address captured from their Driver's License and the Identity Check information that's been obtained. If there is an exact match, there are no discrepancies to resolve and the Check Address button on the Compliance Resolution screen will be disabled. If an exact match does not exist, any unmatched address lines will be identified by the ‘X’ appearing next to the address line(s) that don't match. For example in FIG. 24, the Drivers License information indicates the Customer's Middle Name is H and the Identity Check Address Middle Name is blank.

At the bottom of the Check Address screen is a frame entitled Address Discrepancy Resolution. The frame contains three options: Choosing the 1^{st} option, The Address Discrepancy Is Very Minor and Should Be Ignored or the 2^{nd} option, The Address Discrepancy Can Be Explained and Should Be Ignored (such as a recent address change) will allow any Red Flag Rules initially set to a Not Complaint status because of this discrepancy to be set to a Complaint status. If the 3^{rd} option, The address discrepancy can not be explained and can not be ignored is selected, then all Red Flag Rules currently set to Non Compliant due to that discrepancy will remain that way.

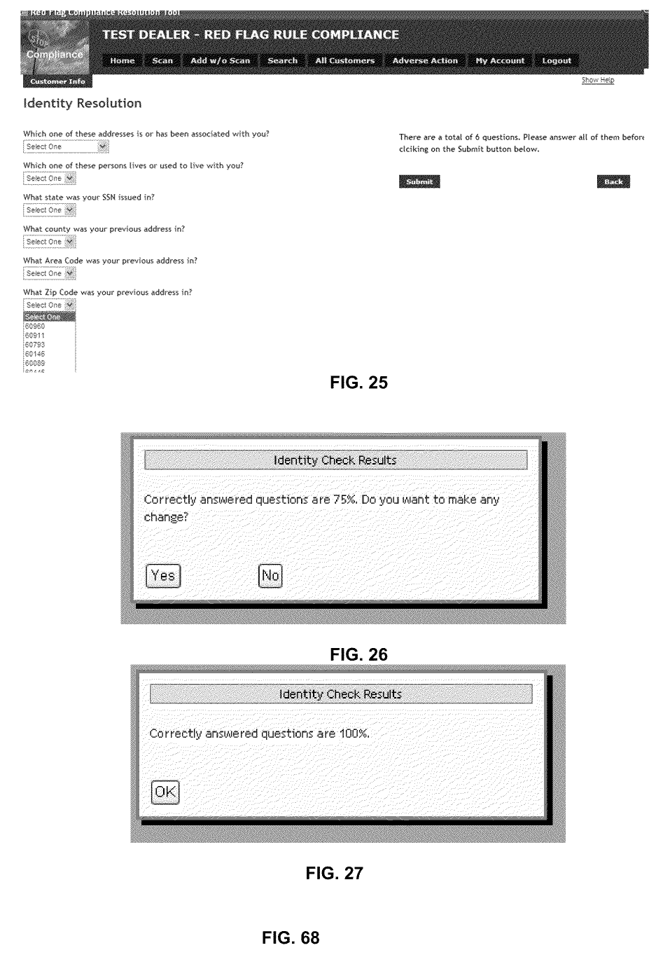

The purpose of the Identity Resolution Screen of FIG. 25 is to enable customers to answer specific questions that have been generated in order for that customer to verify their identity. This option is available with the Comprehensive Version only. Each question will display multiple possible answers for the customer to choose from. After all questions are answered, clicking on the Submit button. A box appears with the percentage of correctly answered questions (FIGS. 26-27).

If the percentage is less than 100% as illustrated in FIG. 26, the customer will have one more opportunity to correct some of their answers. Which questions were answered correctly or incorrectly will not be available. If corrections are to be made, clicking the Yes button as shown in FIG. 26 will enable repeating the answering process for all questions requiring changes.

After clicking the Submit button a second time or if all questions were answered correctly the first time, a screen similar to that of FIG. 27 will appear. The number of correct responses and the percentage will also appear in Verification Question number 4. This question cannot be answered until the Identity Resolution has been completed. Once the Identity Resolution process has been completed, the Identity Resolution button on the Main Compliance Screen will become disabled.

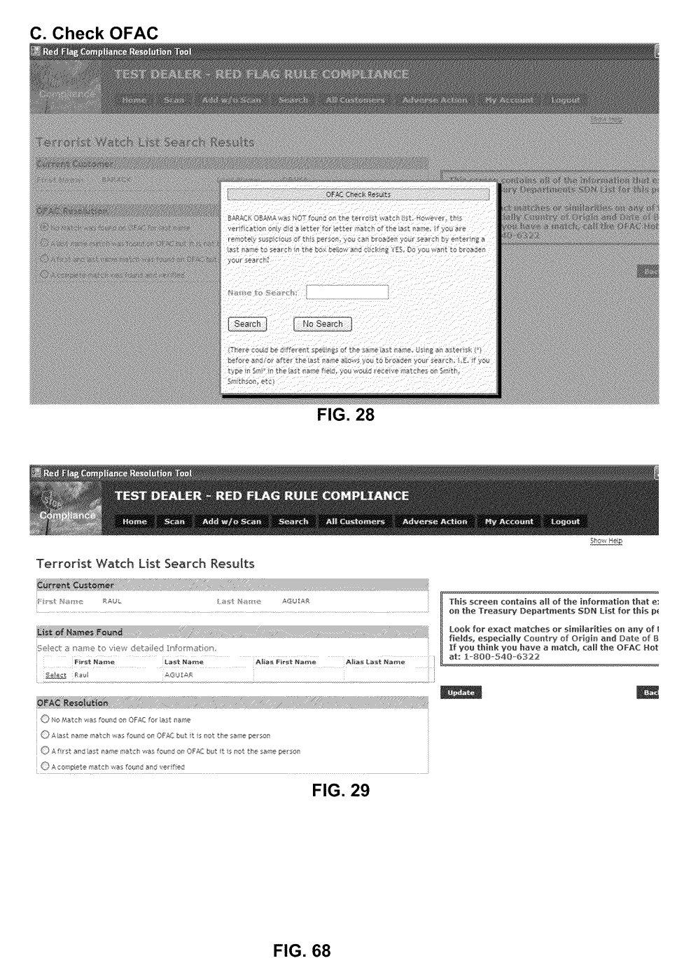

The purpose of the OFAC or Terrorist Watch List screen (See FIG. 28) to verify that the customer does not appear on the OFAC list. The initial OFAC check begins when the Check OFAC button is clicked. The Red Flag Resolution Tool will conduct an automatic letter for letter check of the customer name to determine if it appears on the OFAC list. If not, the user has one more option using the screen shown in FIG. 28. If the user has any suspicion that the Customer may be using another name, a known alias or a different name spelling all of which can be entered and checked against the OFAC information, If a match either from the initial search or the alias search occurs, FIG. 28 will appear.

FIG. 29 displays all results from the Terrorist Watch List Database that matched the initial entry or alias check. The next step in the process is to click the Select button to the left of the displayed name(s) underneath the label titled List of names found.

The Detailed Information as illustrated in FIG. 29 is imported directly from the Terrorist Watch List database. If the identity of the person(s), displayed is definitely NOT the same as the Customer, clicking the close button and Return to the Terrorist Watch List Search results screen. Choose one of the first three options in the OFAC resolution to explain the apparent match, then click the Update button.

FIG. 31 depicts a Terrorist Watch List Screen. If the Customer information appears to match Terrorist Watch List information, the system will instruct the user to follow the directions on the right side of the Terrorist Watch List Search Results or call 1-800-540-6322

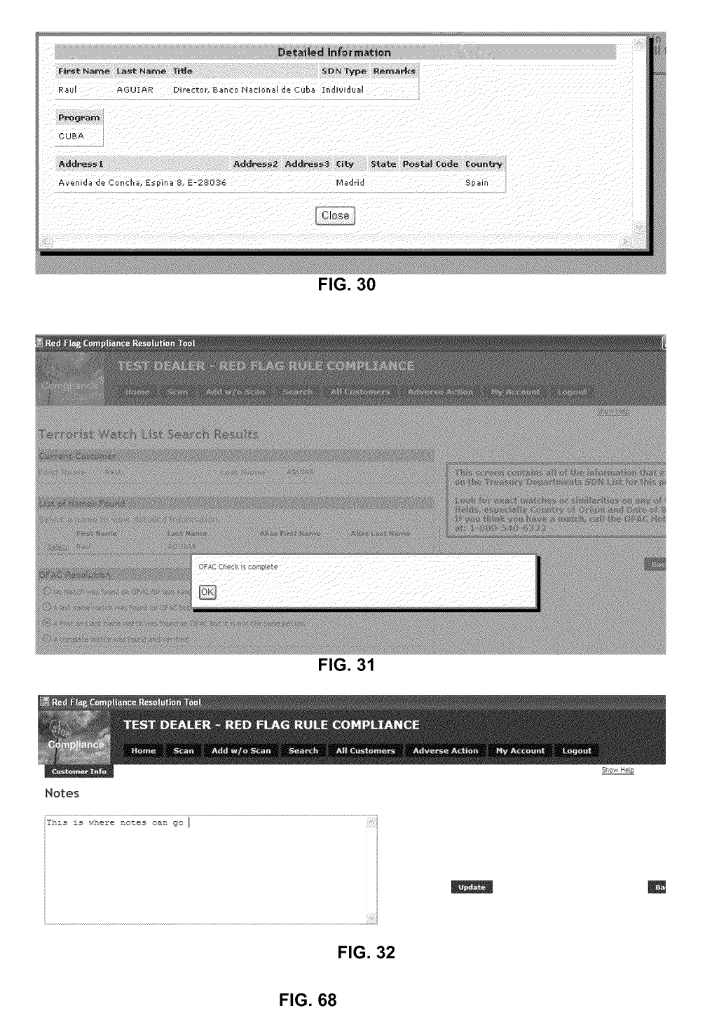

The purpose of the Notes screen of FIG. 32 is to enable additional information to be kept, if necessary, about this customer. For example, the reasons that certain Red Flag Rules could not be made compliant could be listed. The information entered into the Notes screen will also print on a second page on the Red Flags Compliance Report

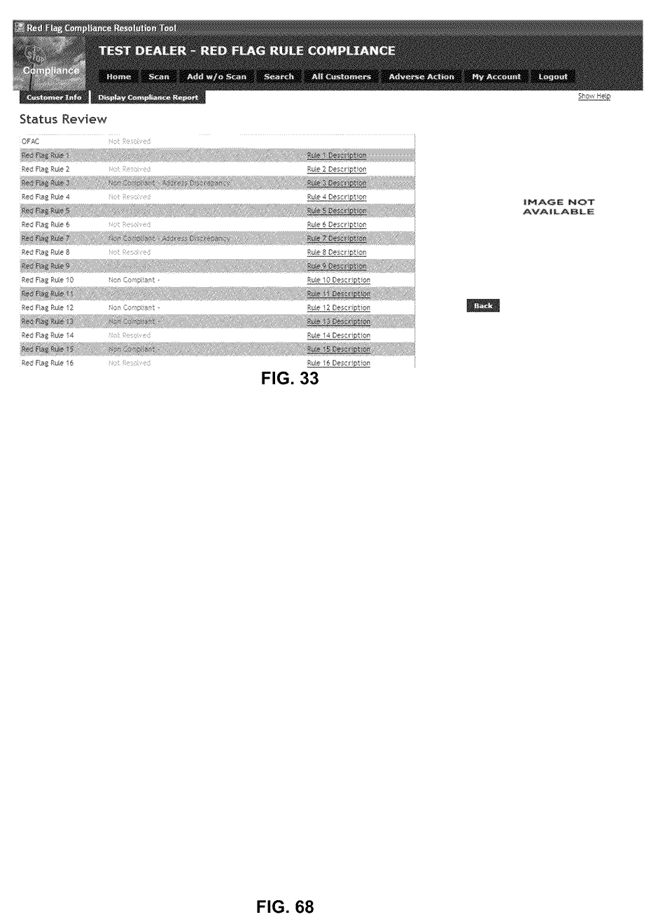

The purpose of the Status Review Screen shown in FIG. 33 is to illustrate the current status for every Red Flag Rule and the OFAC check. If a Red Flag Rule is not complaint then the reason that the rule is not being satisfied will appear. If a rule has been overridden then that fact will also be displayed as well as the original reason the rule had not been satisfied. Another button with the description of the actual rule will appear next to the rule status that can be pressed for reference purposes.

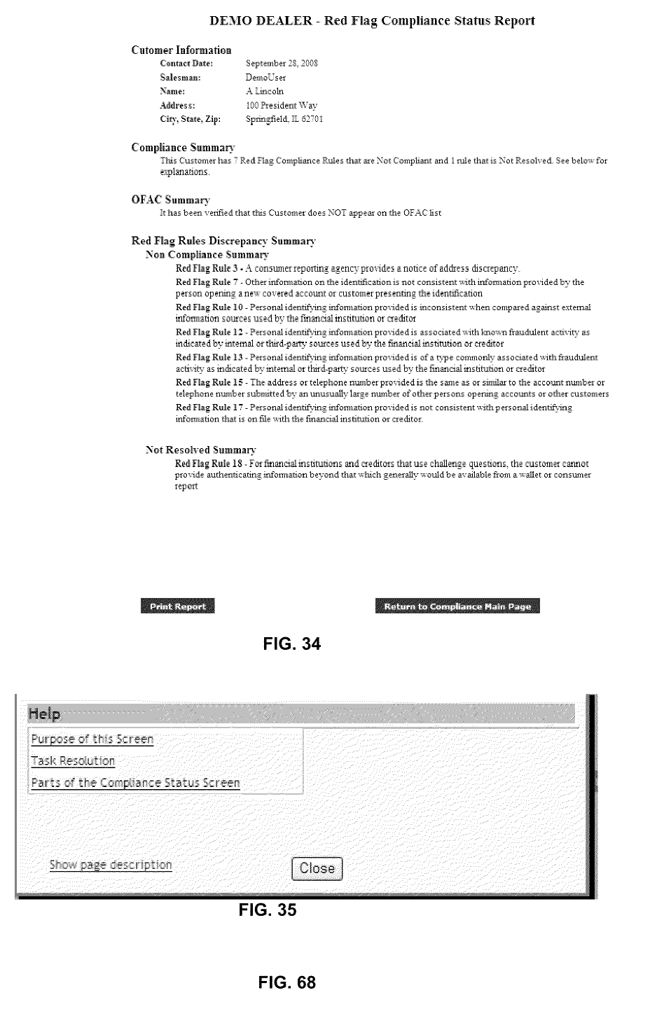

The other important feature on the Status Review screen is the Display Compliance Report button which will generate and display the Red Flag Compliance Status Report (See FIG. 34)

The Red Flag Compliance Status Report of FIG. 34 provides a detailed summary of the status of the Customer's current compliance status. The report can also be printed and inserted in the Customer's Deal jacket.

The Red Flag Rule Compliance Tool has a fairly extensive online help feature. Each screen in the tool has a button in the upper right hand corner of the screen titled Show Help. Clicking on that button will display a panel similar to that displayed in FIG. 35. The illustrated example relates to the Compliance Status Screen.

Most of the Help screens will follow a format similar to the one shown in FIG. 36. There will be several items listed on the left side of the panel. The first item in the list will give the main purpose of that particular screen. Other Help lists may vary, depending on the complexity of the screen but all will probably have at least two other items listed; an item related to the major processes for that screen and another item that identifies the key items on the screen.

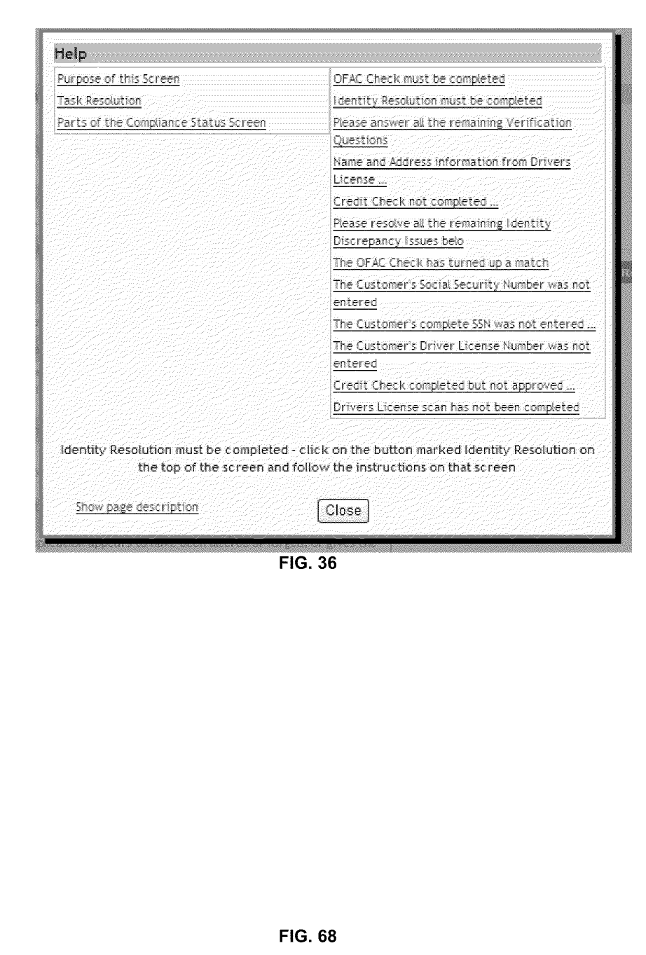

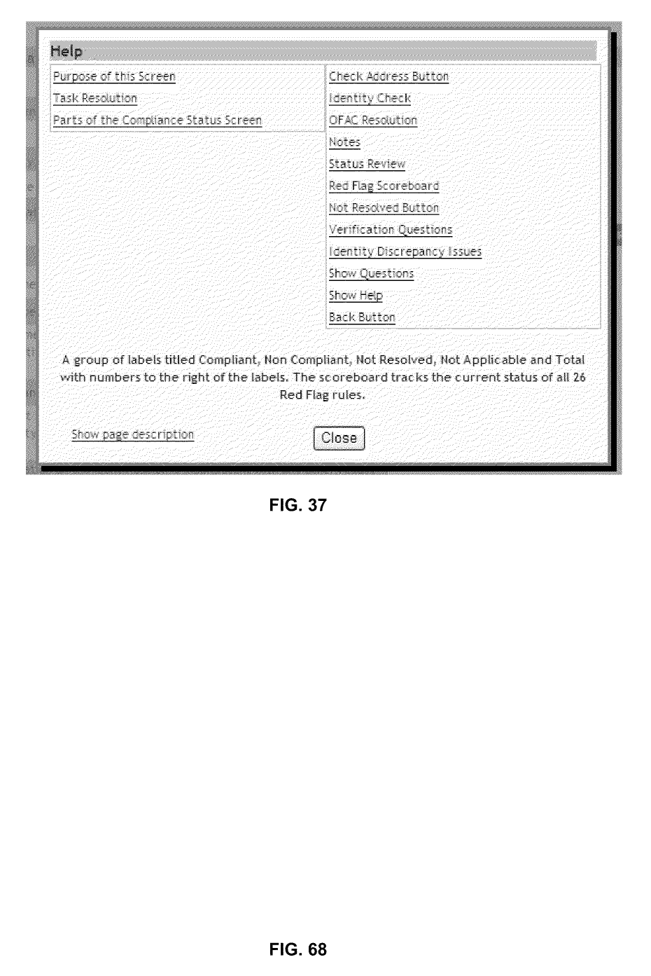

Clicking on the appropriate text on the right side will bring up the Help Information requested. For example, clicking on Identity Resolution must be completed in FIG. 36 will display FIG. 37 for example.

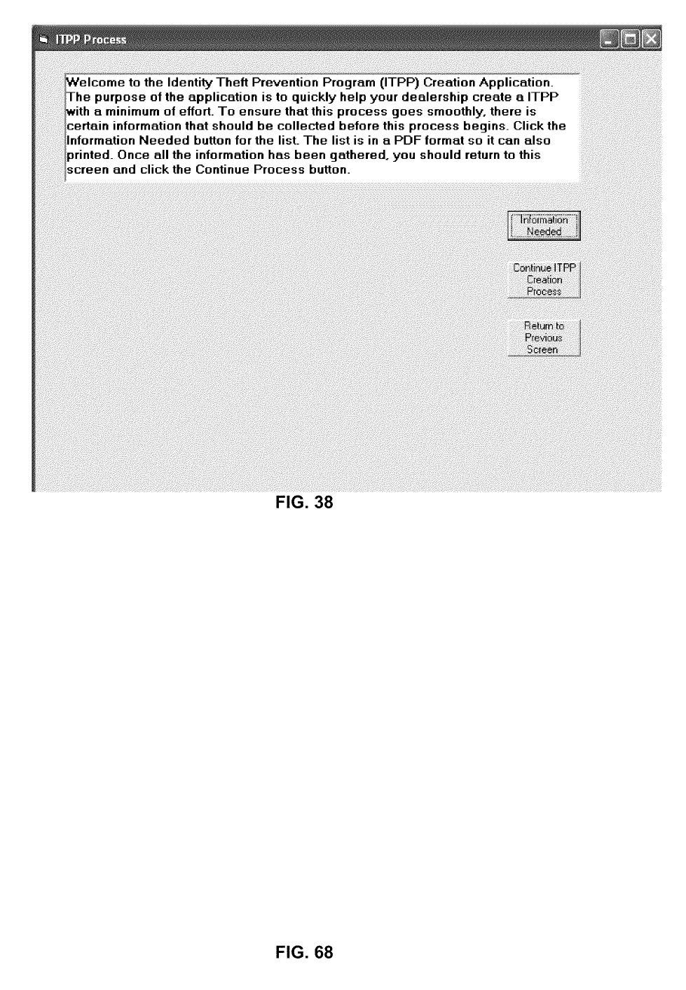

One embodiment of the invention relates to an Identity Theft Prevention Program Creation and Maintenance Tool or Module providing a simple step-by-step process to create an Identity Theft Prevention Program (“ITPP”). FIG. 38 depicts a screenshot illustrating the ITPP Process Screen in accordance with one embodiment. The major goal of the ITPP is to identify covered accounts and the level of risk for each type of account. The system prompts the user to enter several pieces of information and answer a few questions, then generates an Identity Theft Prevention Program in a matter of minutes. The ITPP can be printed at any time or modified as necessary to maintain compliance. Step 1 of the process is to provide a customer a list of documents and information they'll need to create the program.

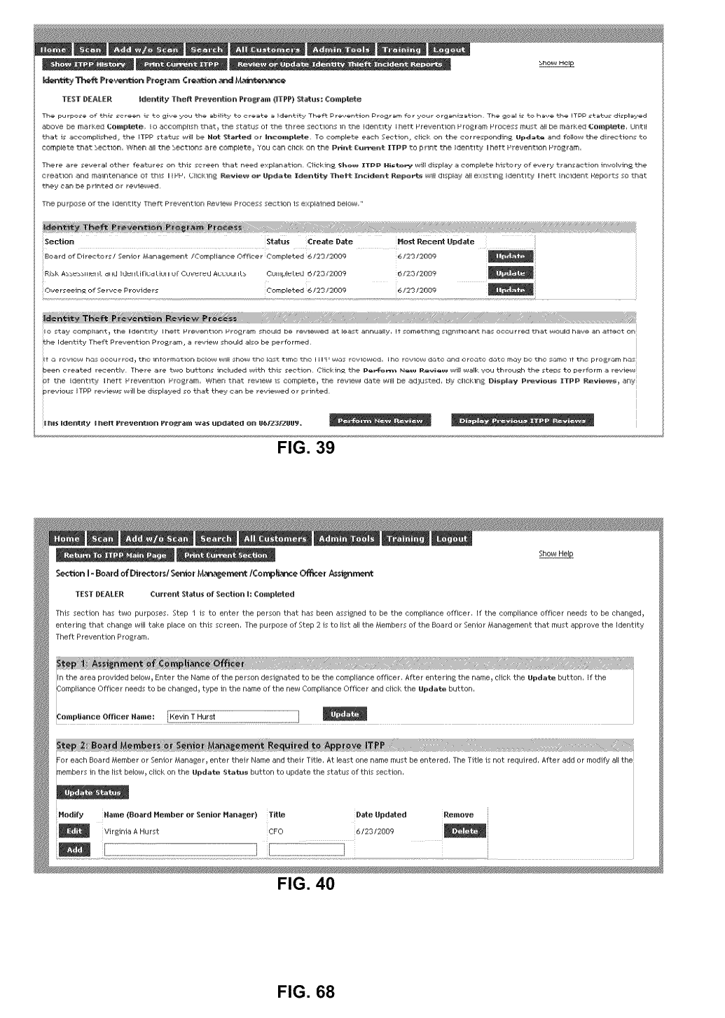

FIG. 39 depicts a screenshot illustrating the Identity Theft Prevention Program Screen in accordance with one embodiment, where the majority of the processes for the ITPP will be initiated. The screen illustrated in FIG. 39 is where the Program Review process section, the Identity, the Identity Theft Incident section and ITPP History screens are initiated. These functions will be described elsewhere.

FIG. 40 depicts a screenshot illustrating the Identity Theft Prevention Program Creation and Maintenance Screen in accordance with one embodiment. This screen illustrates where the Compliance Officer is assigned and any Board Members or Senior Management required to approve the ITPP are assigned.

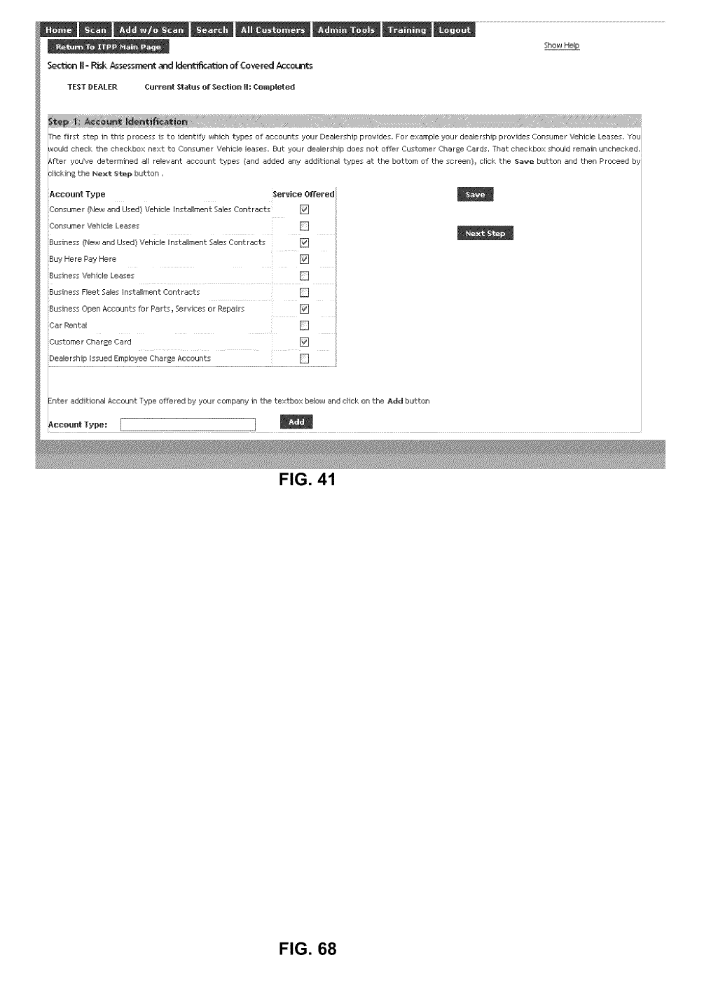

FIG. 41 depicts a screenshot illustrating the Risk Assessment Screen in accordance with one embodiment, the next step in the process is the Risk Assessment.

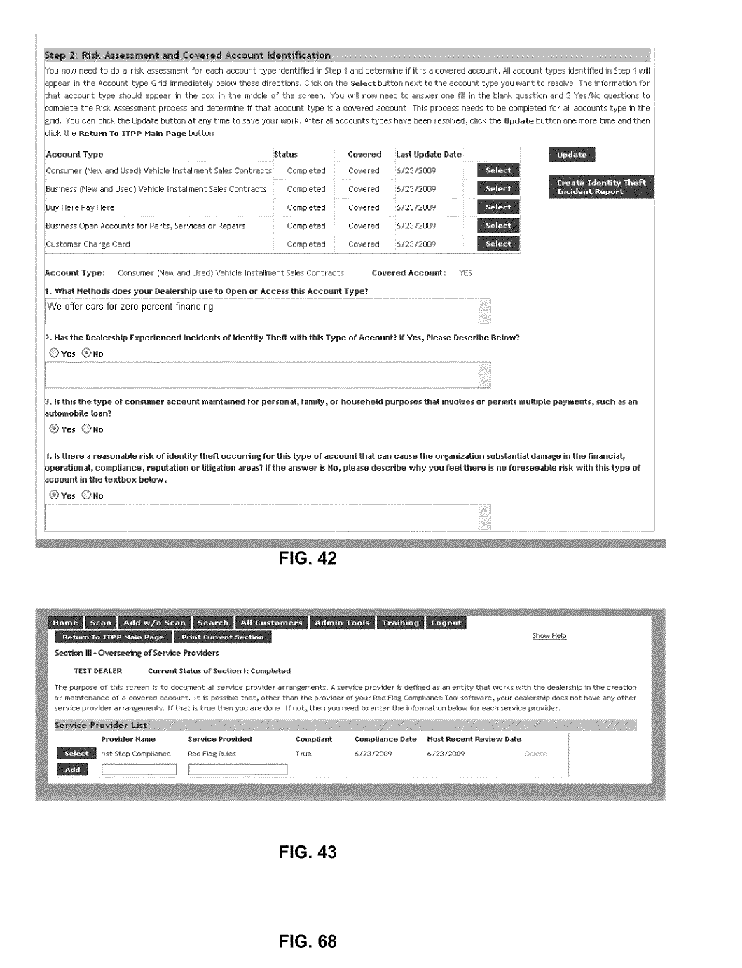

FIG. 42 depicts a screenshot illustrating the Risk Assessment and Covered Account Identification Screen in accordance with one embodiment. This form must be completed for each account type checked off in the screen of FIG. 41. The four questions must be answered and some of those questions may require an explanation depending on the answer chosen.

FIG. 43 depicts a screenshot illustrating the Overseeing of Service Providers Screen in accordance with one embodiment, the next step is the completion of the Overseeing of Service Providers, which helps the customer with the creation or maintenance of a covered account.

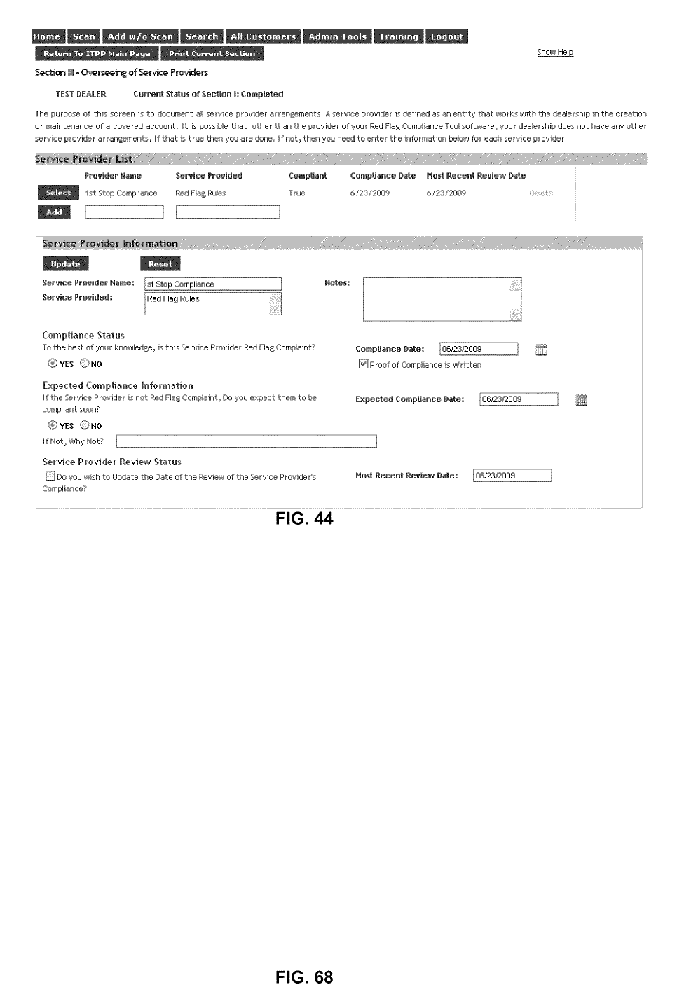

FIG. 44 depicts a screenshot illustrating the Overseeing of Service Providers Screen in accordance with one embodiment. This screen expands and information for the service provider can be added or updated.

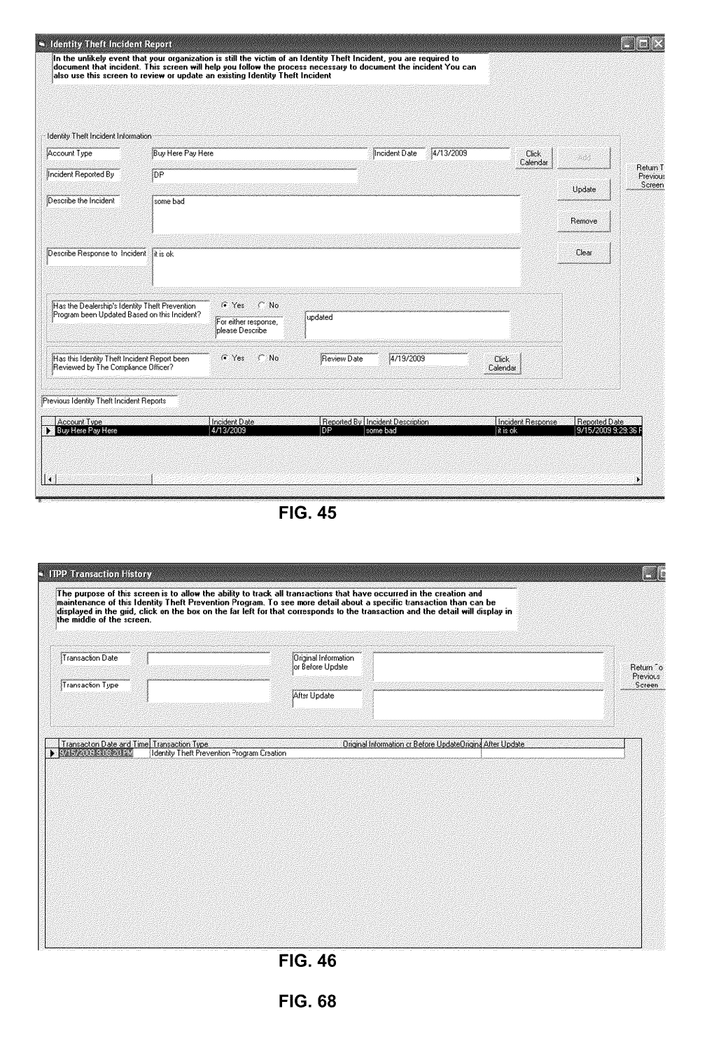

FIG. 45 depicts a screenshot illustrating the Identity Theft Incident Report Screen in accordance with one embodiment. This screen allows a customer to create a Identity Theft Incident Report. The FTC requires that if an actual Identity Theft occurs that this document be filled out.

FIG. 46 depicts a screenshot illustrating the Transaction History Screen in accordance with one embodiment. This screen enables an audit trial of each entry into the creation and maintenance of the Identity Theft Prevention Program is logged and can be displayed for monitoring and audit purposes.

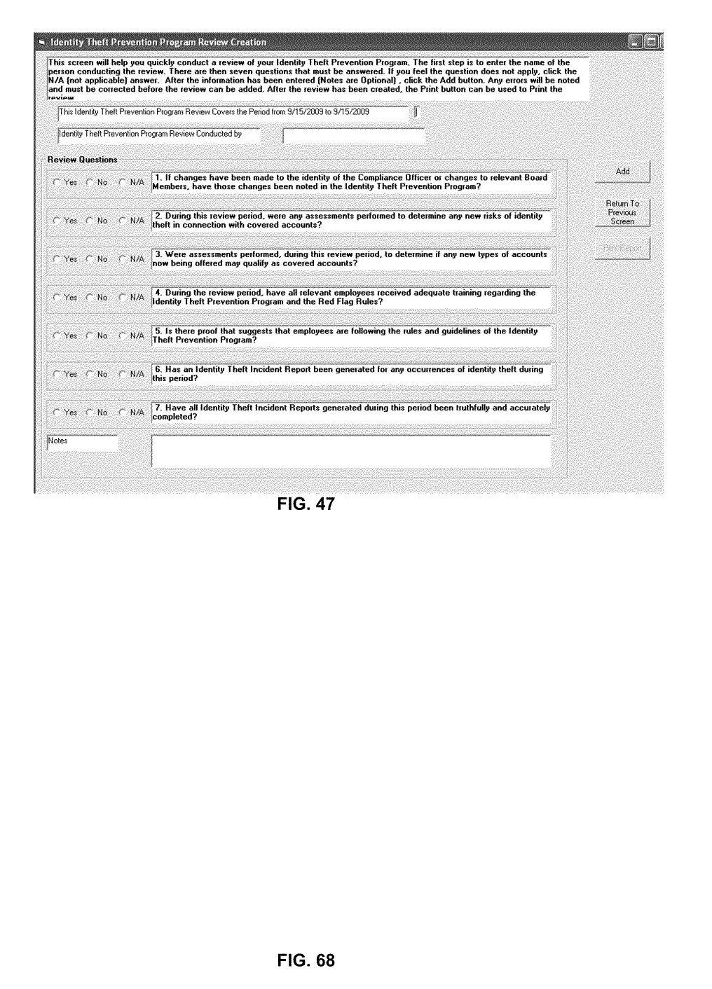

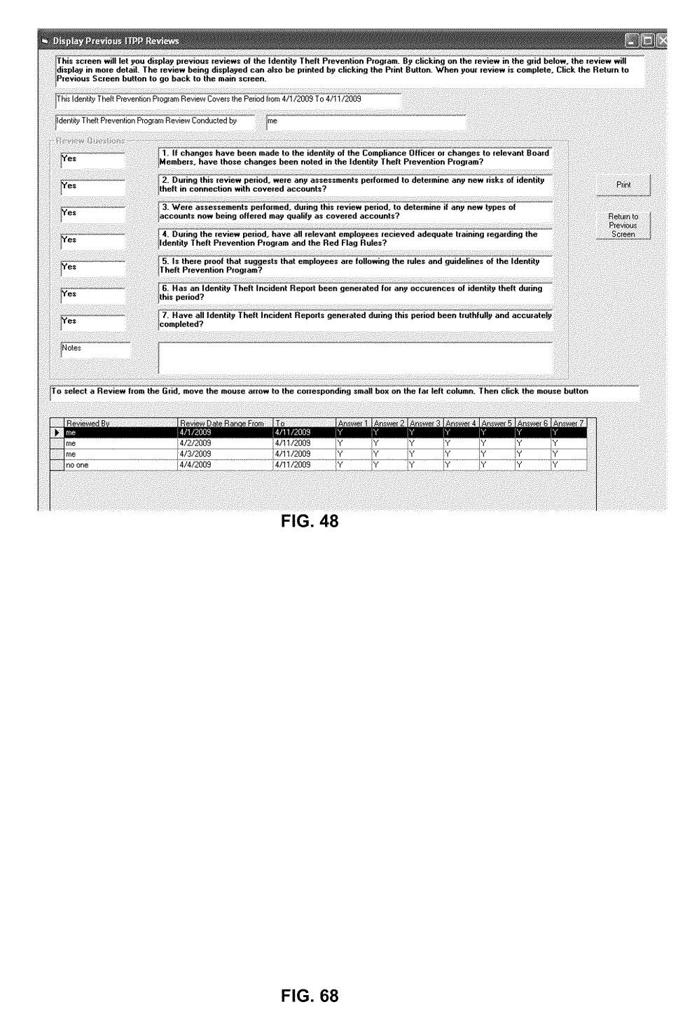

FIG. 47 depicts a screenshot illustrating the Detailed Information Screen in accordance with one embodiment. This screen provides a final feature of the ITTP creation and maintenance process is to provide a review function. Additionally, this screen provides the process to review the ITPP. FIG. 48 depicts a screenshot illustrating the Previous ITPP Reviews Screen, where if an audit is required demonstrates that reviews exist.

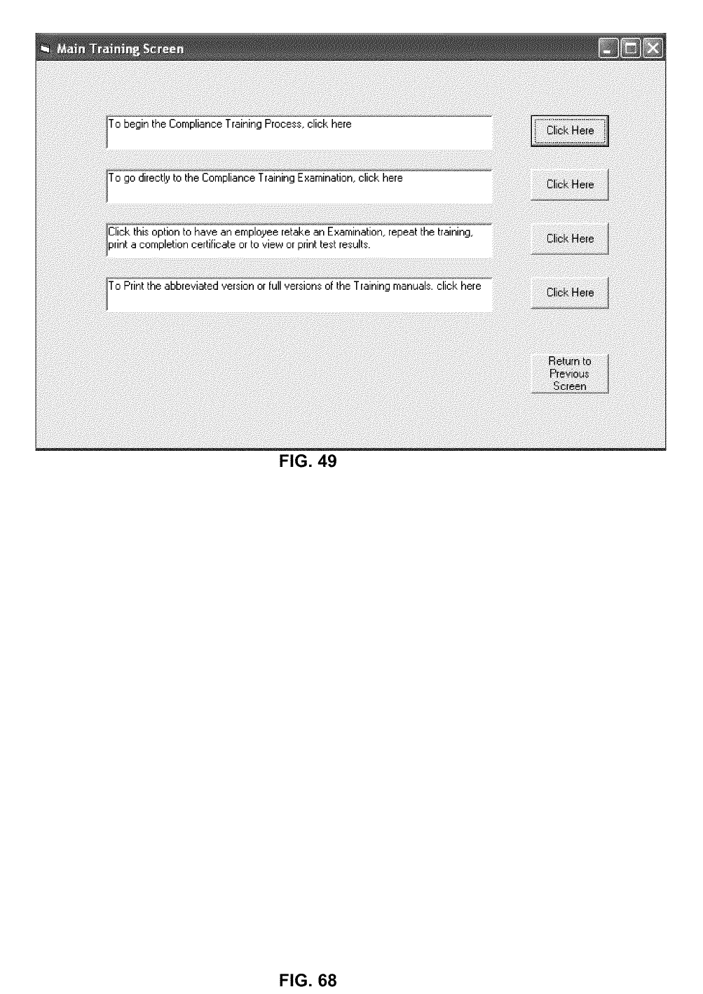

In at least one embodiment, the Employee Training Module contains two sections, the Training Guide including direct references from the FTC official documents and the Testing program which offers a test to complete the training process. FIG. 49 depicts a screenshot illustrating the Main Training Screen in accordance with one embodiment. The Main Training Screen includes four options, Beginning the Compliance Training Process, taking the Exam itself, a repeat or continue of the training process or printing the materials needed for the process.

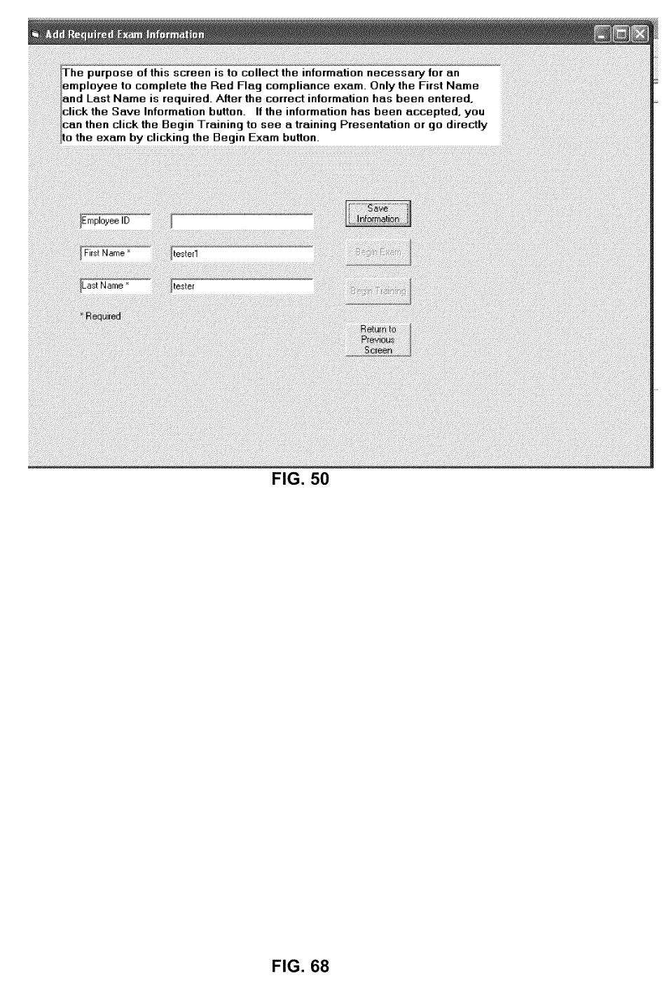

FIG. 50 depicts a screenshot illustrating the Beginning the Compliance Training Process Screen in accordance with one embodiment which appears after clicking the Begin the Training Process button, this screen will appear. This screen collects information necessary for the Employee to complete the Red Flag compliance exam.

FIG. 51 depicts a screenshot illustrating the Red Flag Rules Training Screen. If the Begin Training process is chosen, a serious of screens similar to the one above will appear. Navigation buttons to Display Next or Display Previous will appear to go forward or backward through the training slides. At any point or after the last slide, the employee can click the Begin Exam button to start the Exam.

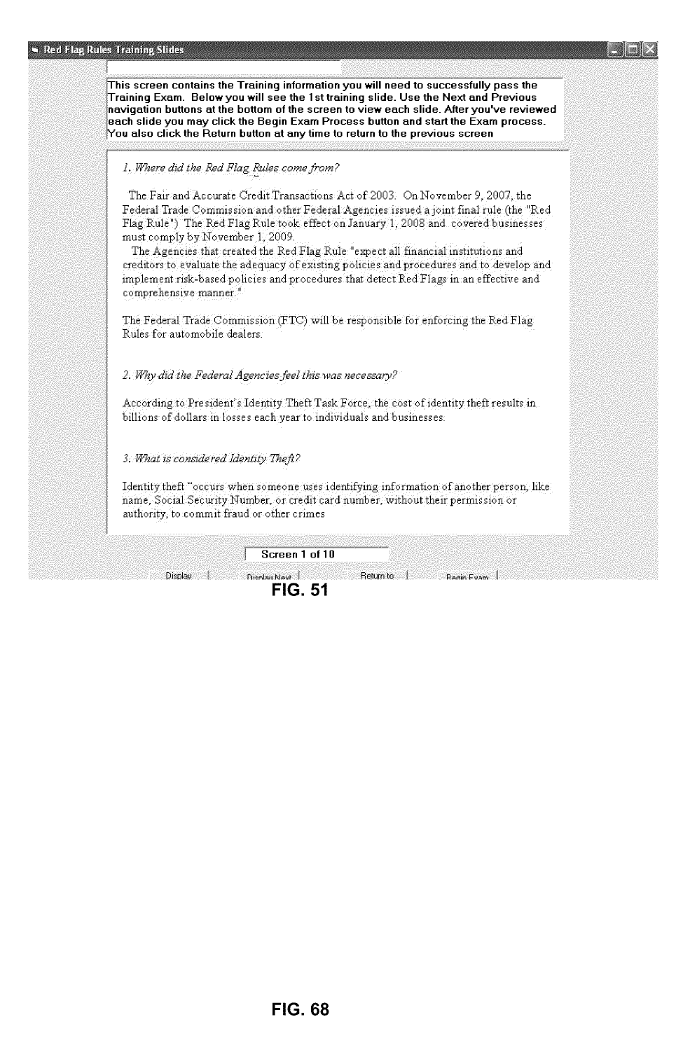

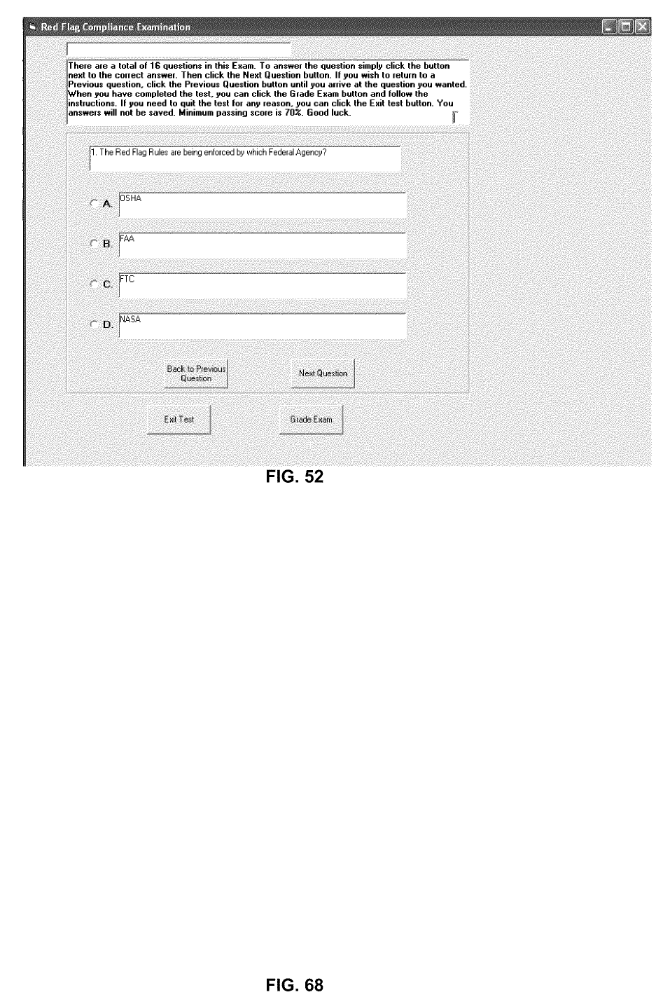

FIG. 52 depicts a screenshot illustrating the Red Flag Compliance Examination Screen in accordance with one embodiment, the first screen of the test process.

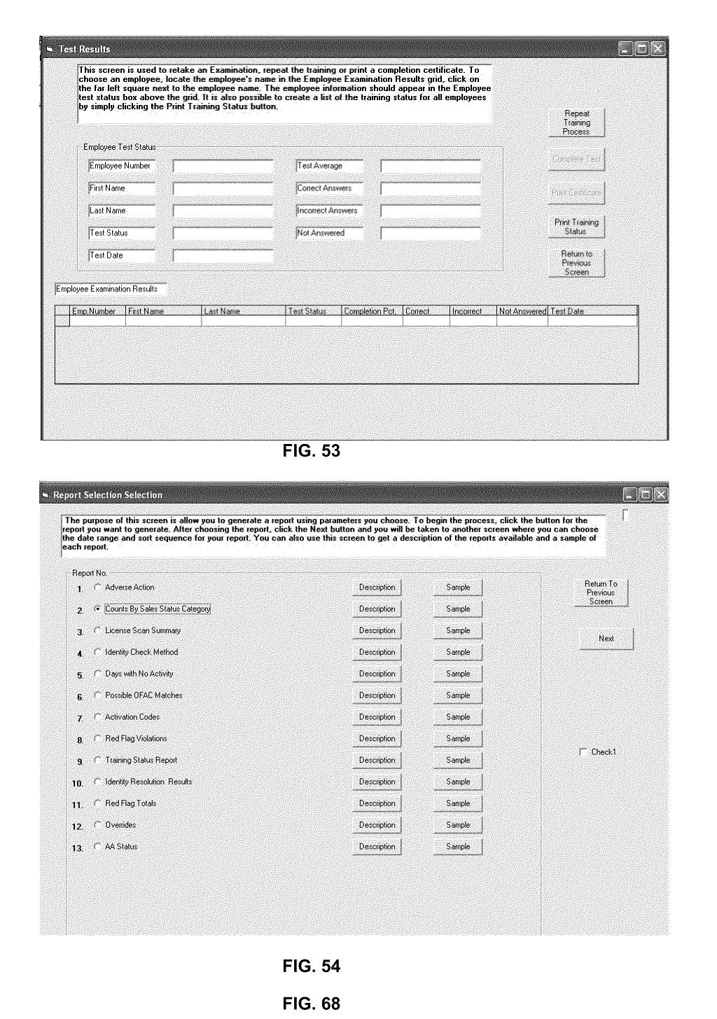

FIG. 53 depicts a screenshot illustrating the Test Results Screen in accordance with one embodiment, This is the final screen available to administrators. It depicts the status of everyone that has attempted to take the exam. It provides detailed information about the test score and the breakout of correct, incorrect and unanswered questions. From this screen it is also possible to print a status report, a completion certificate or restart the training process at the beginning or some intermediate point.

A plurality of user reports has been created for users to ensure that their organization stays compliant. These reports can track the frequency of when the Red Flag Tool (and which version) was used, any violations that were discovered and how they were resolved, how often overrides were required and whether any violations remain unresolved. Other reports can also indicate any possible OFAC violations or Adverse Action details.

The Reports Tool or module provides the flexibility to extract the report information using a specific time frame (by day, week or month) or by date ranges (between two dates, between the first day of one week (or month) and the last day of another week (or month). The data can be formatted to show summary counts only or to show the customer information that matched the selection criteria. The outputs of the Report Tool may be a screen display, a standard printed report or exported as an Excel file.

FIG. 54 depicts a screenshot illustrating the first screen of the Report Process or the Report Selection Screen in accordance with one embodiment, which displays all reports that are available.

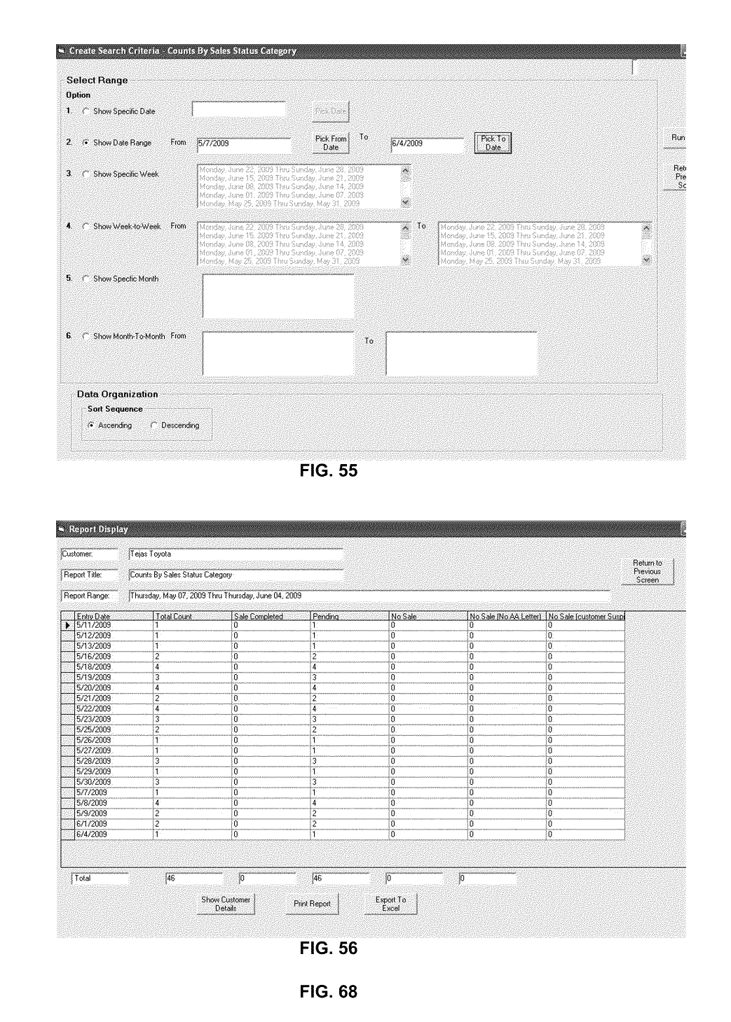

FIG. 55 depicts a screenshot illustrating the Create Search Criteria Screen in accordance with one embodiment which depicts the date and sorting parameters available.

FIG. 56 depicts a screenshot illustrating the Report Display Screen in accordance with one embodiment which shows the results of the output. This report can be printed or exported to Excel.

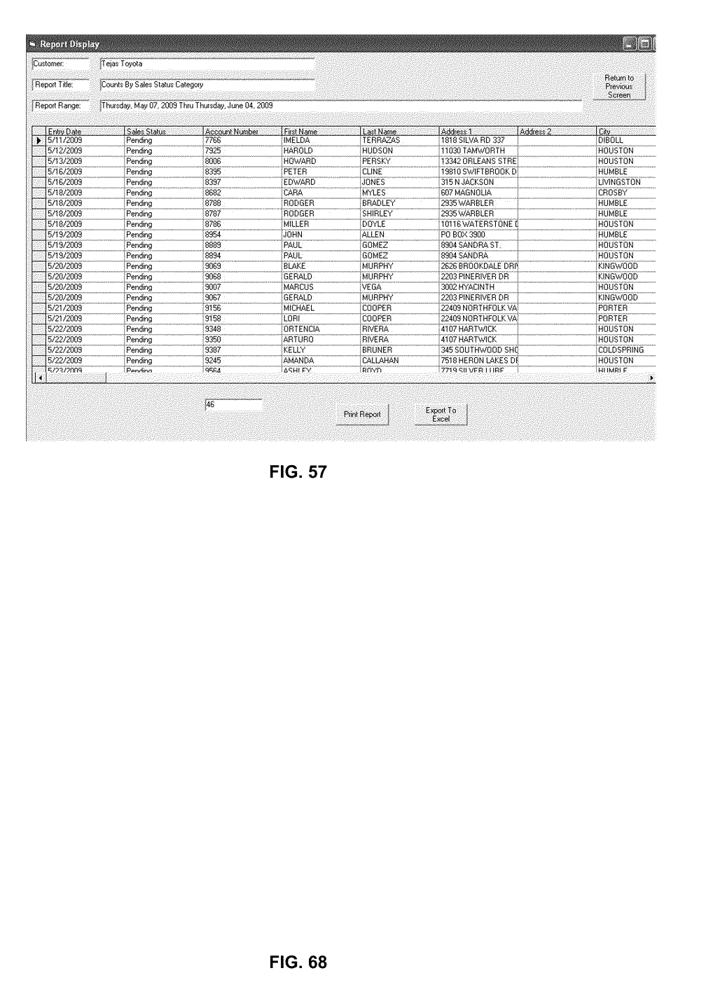

FIG. 57 depicts a screenshot illustrating the Report Display Screen in accordance with one embodiment. This report can also be printed or exported to Excel.

Embodiments of the invention include a Red Flag Violation Notification feature, the purpose of which is to generate notifications in email format for example, to notify senior management or anyone else designated at the business in the event that a compliance violation has occurred. This process will occur overnight so that all transactions from the previous day will be reviewed. These violations may be actual Red Flag violations or some flaw in the process that may indicate a training issue. The availability of this process will resolve the requirements needed to fulfill the Administrating the Program and Preventing and Mitigating Identity theft sections.

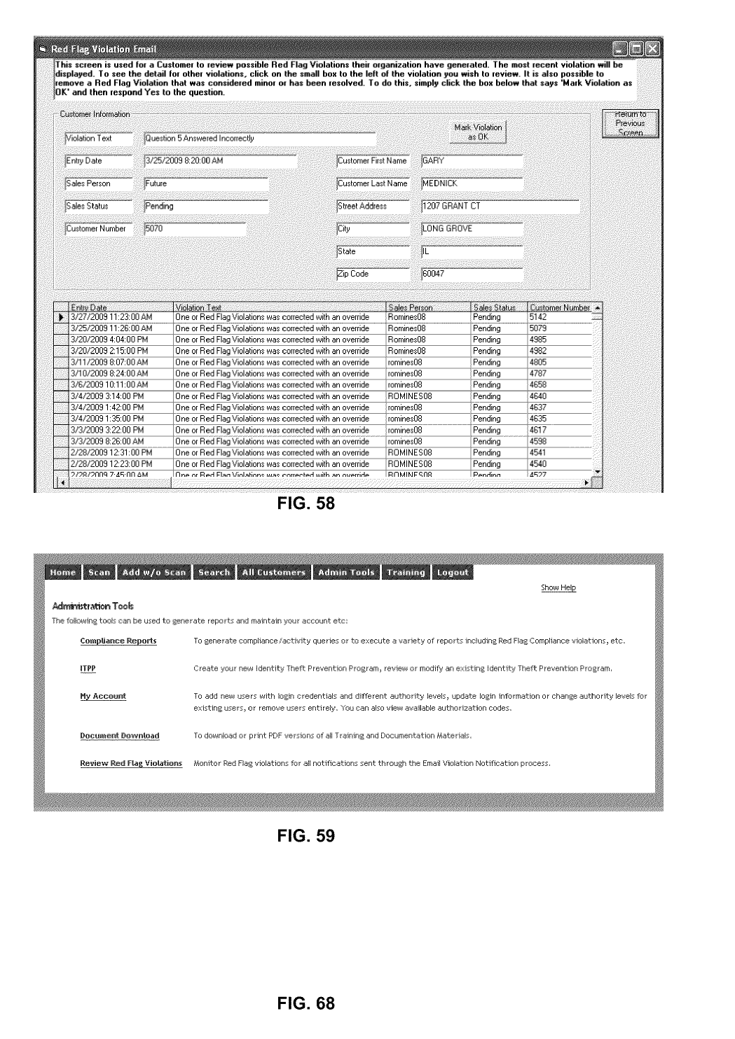

FIG. 58 depicts a screenshot illustrating the Red Flag Violation Email Screen in accordance with one embodiment. There are two ways to access this screen. When an email is generated informing a user that a potential violation or discrepancy has occurred, clicking the email link will cause the screen illustrated in FIG. 58 to appear. The other way to display this screen is by clicking the Red Flag Violation screen from the User Main screen. This screen provides detail about potential violations.

Embodiments of the invention include Administration Tools or modules. FIG. 59 depicts a screenshot illustrating the Administration Tools Screen in accordance with one embodiment. Clicking the Admin Tools button on this screen displays the main menu screen. The Compliance Reports, Identity Theft Prevention Program (ITPP) and Review Red Flag Violations functions are explained previously. The My Account and Document Download are explained below.

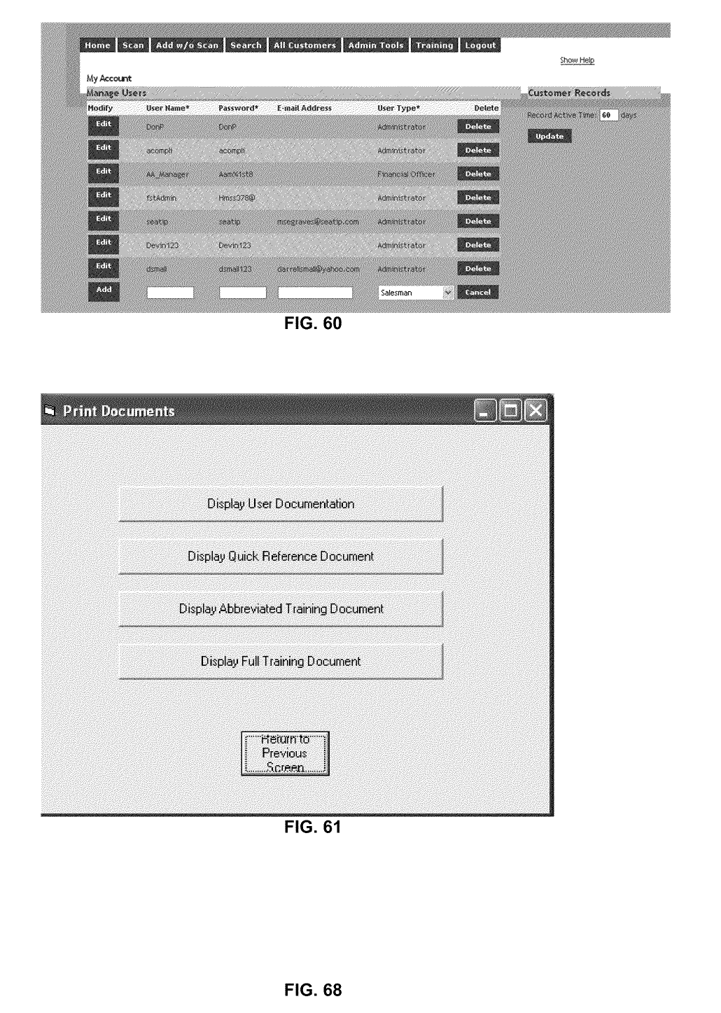

FIG. 60 depicts a screenshot illustrating the My Account and Document Download Screen in accordance with one embodiment. Access to the system requires a user name and password. The screen illustrated in FIG. 61 enables new user names, passwords and user type to be added or existing users changed or removed. The User Type determines the access authority the user has, which can also be changed for existing accounts.

FIG. 61 depicts a screenshot illustrating the Print Document Screen in accordance with one embodiment. All documents such as training documents, user documentation and quick reference documents can be accessed here.

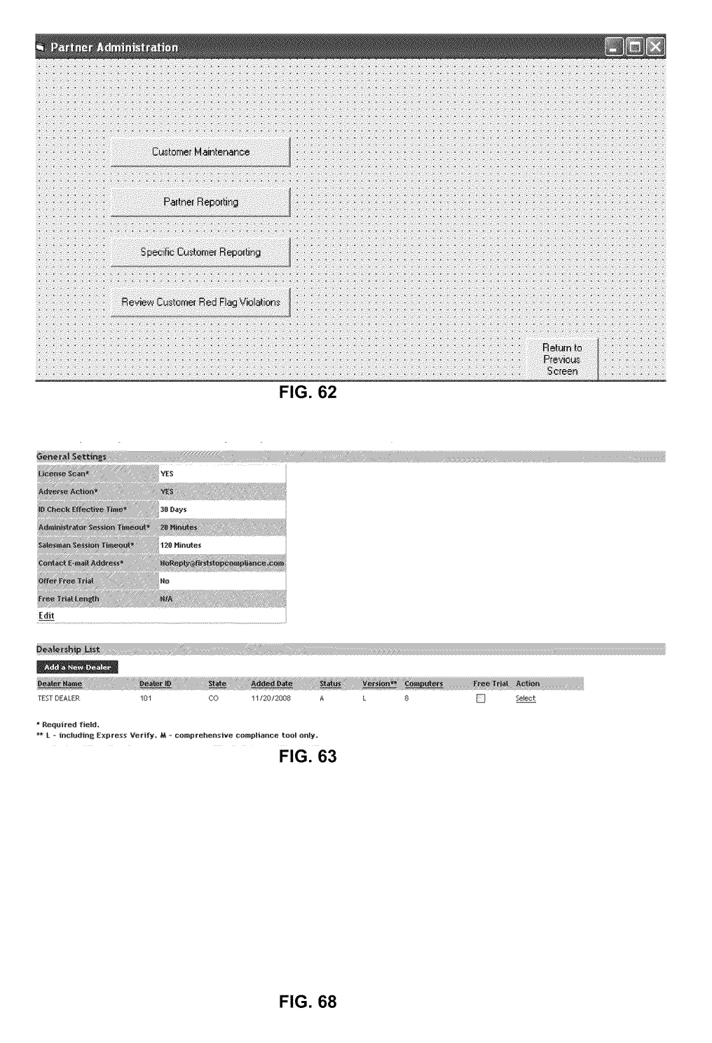

Embodiments of the invention enable partnering, in which other users are designated as Partners. A partner may be a Dealer Management System or some other affiliation of a user, in which multiple customers are interfacing with their product and the Red Flag product. After logging into that screen, the Partner Administration Screen illustrated in FIG. 62 will appear in accordance with one embodiment.

FIG. 63 depicts a screenshot illustrating the Customer Maintenance Screen in accordance with one embodiment. This is where new Customers are added or the product authorization such as free trials, version availability, and payment status are controlled.

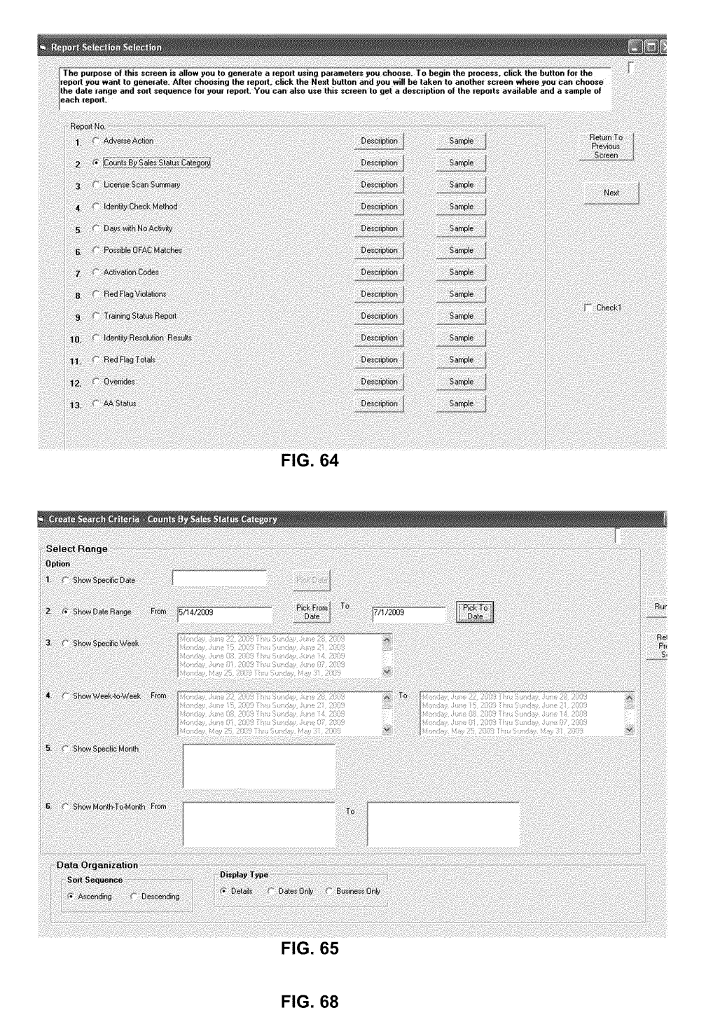

FIG. 64 depicts a screenshot illustrating the Partner Reporting Screen in accordance with one embodiment. This screen is similar to the Report selection screen individual users receive, except the box titled Display Type. The three illustrated options enable the Partner user to filter the grouping of data by Business Only (each customer) by Date Only (each distinct date will appear but all customers will be grouped by date) or by Detail which will show all customers and each date.

After clicking the Run Report button, the next screen will display the summary information and it can be printed or create as an Excel file. It is also possible for some reports to have the individual data display. This screen is similar to the date selection screen for individual customers except for box titled Display Type. These 3 options allow the Partner user to filter the grouping of data by Business Only (each customer) by Date Only (each distinct date will appear but all customers will be grouped by date) or by Detail which will show all customers and each date.

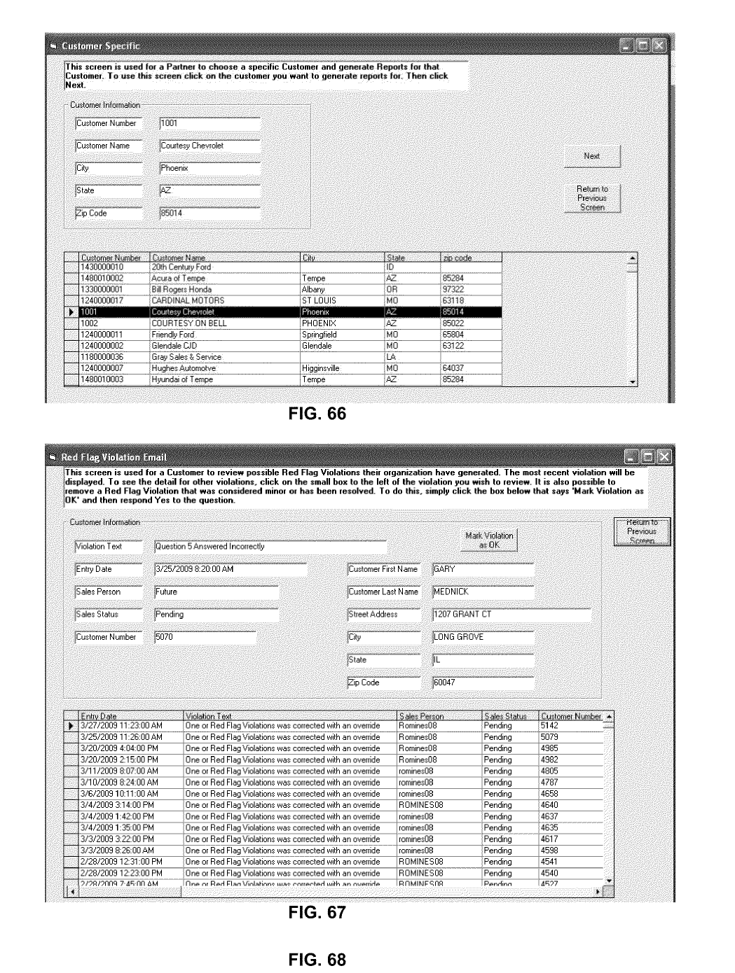

After clicking the Run Report button, the screen illustrated in FIG. 65 (the Create Search Criteria Screen) will display the summary information and can be printed or created as an Excel file. It is also possible for some reports to have the individual data display. If a Partner user wishes to see reports about a specific customer they are affiliated with, then clicking the Customer Specific Reporting will display this screen. By clicking the customer in the list and then clicking NEXT, the same reporting screen as the screen illustrated in FIG. 66 as above will appear but the system will only generate reports for that customer.

In at least one embodiment, Red Flag Violations can be reviewed at the Partner Level. A screen (not shown) can display all affiliated customers (similar to above) total resolved violations, unresolved violations and most recent unresolved violation. By clicking on a specific dealer and clicking next, the screen depicted in FIG. 67 illustrating the Red Flag Violation Email will be displayed.

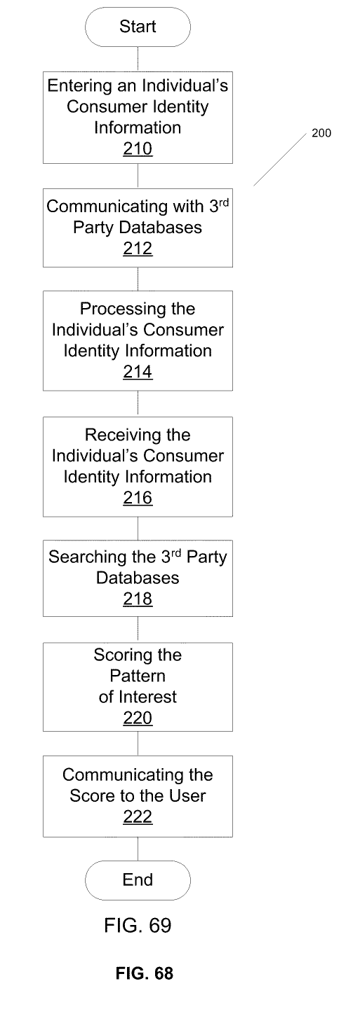

FIG. 68 depicts a high level flow diagram illustrating a method for verifying an individual's identify and preventing identify theft, generally designated 200. The method 200 comprises entering an individual's consumer identity information using at least one input device block 210 and communicating with third party databases storing identity data using a network communicating with at least one input device, block 212. Method 200 further processes the entered individual's consumer identity information using a processing unit communicating with at least one of the input devices, third party databases and the network, block 214. Additionally, the method 200 includes the processing unit containing instructions operating thereon for receiving the individual's consumer identify information from the input device block 216; searching the third part databases using the received individual's consumer identify information to identify at least one pattern of interest in at least one alert category, block 218; scoring the at least one pattern of interest as a function of at least one Red Flag Rule, block 220; and communicating the score to a user in combination with any resolution means, block 222.

One or more embodiments of the method 200 may include modifying the consumer identity information using wild card characters. Further, the method 200 may include scoring the at least one pattern of interest comprises the individual's consumer identity information not matching the identify information in at least one of the third party databases and the at least one alert category is selected from the group comprising aliases, identity discrepancies, address discrepancies, fake addresses, fake credit histories.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A system for verifying an individual's identify and preventing identify theft, the system comprising:
a. at least one input device for entering an individual's consumer identity information;
b. third party databases storing identity data;
c. a network communicating with the third party databases and the at least one input device; and
d. a processing unit communicating with at least one of the input devices, the third party databases and the network, the processing unit containing instructions operating thereon for:
i. receiving the individual's consumer identify information from the at least one input device;
ii. searching the third party databases using the received individual's consumer identify information to identify at least one pattern of interest in at least one alert category;
iii. scoring at least the one pattern of interest as a function of at least one Red Flag Rule; and
iv. communicating the score to a user.

2. The system of claim 1 further comprising modifying the consumer identify information using wild card characters.

3. The system of claim 1 wherein the at least one input device is selected from the group comprising desktops, laptops, netbooks, PDA devices and cellphones.

4. The system of claim 1 wherein the at least one input device comprises at least one scanner device.

5. The system of claim 1 wherein the network is selected from the group consisting of cabled, wired, wireless networks and combinations thereof.

6. The system of claim 1 wherein scoring at least the one pattern of interest comprises not matching the individual's consumer identity information with the identify information in at least one of the third party databases.

7. The system of claim 1 wherein the at least one alert category is selected from the group comprising aliases, identity discrepancies, address discrepancies, fake addresses, fake credit histories.

8. The system of claim 1 wherein communicating the score comprises transmitting an email notification.

9. A system for verifying an individual's identity and preventing identify theft, the system comprising:
a. at least one input device for entering an individual's consumer identity information;
b. third party databases storing identity data;
c. a network communicating with third party databases and the at least one input device; and
d. a processing unit communicating with at least one of the input device, the third party databases and the network, the processing unit containing instructions operating thereon for:
i. verifying the individual's identity;
ii. identifying a theft prevention plan;
iii. providing user training;
iv. providing reports;
v. providing red flag notification;
vi. enabling user administration; and
vii. enabling partnering with other users and administering such partnering.

10. The system of claim 9 wherein verifying the individual's identity comprises the processing unit containing instructions operating thereon for:
a. receiving the individual's consumer identify information from the input device;
b. modifying the individual's consumer identity information using wild card characters;
c. searching the third part databases using the received individual's consumer identify information to identify at least one pattern of interest in at least one alert category;
d. scoring at least the one pattern of interest as a function of at least one Red Flag Rule; and
e. communicating the score to a user.

12. The system of claim 10 wherein the at least one input device is selected from the group comprising desktops, laptops, netbooks, PDA devices and cellphones.

13. The system of claim 10 wherein the at least one input device comprises at least one scanner device.

14. The system of claim 10 wherein the network is selected from the group consisting of cabled, wired, wireless networks and combinations thereof.

15. The system of claim 1 wherein scoring the at least one pattern of interest comprises not matching the individual's consumer identity information with the identify information in at least one of the third party databases.

16. The system of claim 1 wherein the at least one alert category is selected from the group comprising aliases, identity discrepancies, address discrepancies, fake addresses, fake credit histories.

17. The system of claim 10 wherein communicating the score comprises sending at least the user an email.

18. A method for verifying an individual's identify and preventing identify theft, the method comprising:
a. entering an individual's consumer identity information using at least one input device;
b. communicating with third party databases storing identity data using a network communicating with at least the one input device; and
c. processing the entered individual's consumer identity information using a processing unit communicating with at least one of the input devices, third party databases and the network, the processing unit containing instructions operating thereon for:
i. receiving the individual's consumer identify information from the input device;
ii. searching the third part databases using the received individual's consumer identify information to identify at least one pattern of interest in at least one alert category;
iii. scoring at least the one pattern of interest as a function of at least one Red Flag Rule; and
iv. communicating the score to a user.

19. The method of claim 18 further comprising modifying the individual's consumer identity information using wild card characters.

20. The method of claim 18 wherein scoring the at least one pattern of interest comprises not matching the individual's consumer identity information with the identify information in at least one of the third party databases and the at least one alert category.
